(19) United States
(12) Patent Application Publication
(10) Pub. No.: US 2022/0120217 A1
(43) Pub. Date: Apr. 21, 2022

(54) POWER CELLS AND HEAT TRANSFER SYSTEMS FOR COMBINED HEAT AND POWER, AND RELATED SYSTEMS AND METHODS

(71) Applicant: Modern Electron Inc., Bothell, WA (US)

(72) Inventors: Justin B. Ashton, Menlo Park, CA (US); Max N. Mankin, Seattle, WA (US); Daniel Kraemer, Mukilteo, WA (US); David J. Menacher, San Francisco, CA (US); Patrick D. Noble, Seattle, WA (US); William Kokonaski, Edmonds, WA (US); Peter J. Scherpelz, Seattle, WA (US); Kristen M. Palughi, Seattle, WA (US); Vikas Patnaik, Bothell, WA (US); Samantha A. Tran, Woodinville, WA (US)

(21) Appl. No.: 17/503,187

(22) Filed: Oct. 15, 2021

Related U.S. Application Data
(60) Provisional application No. 63/093,158, filed on Oct. 16, 2020.
(60) Provisional application No. 63/128,866, filed on Dec. 22, 2020.
(60) Provisional application No. 63/224,074, filed on Jul. 21, 2021.

(51) Int. Cl. F02C 6/18; F28D 21/00; F01K 5/02

(52) U.S. Cl. CPC F02C 6/18; F01K 5/02; F28D 21/001

(57) ABSTRACT

Combined heat and power (CHP) systems and related methods are disclosed herein. In some embodiments, the CHP system includes a combustion component and a power cell operably coupled to the combustion component. The power cell can include a first heat exchanger thermally coupled to the combustion component to receive heat; a second heat exchanger; and an electricity generation component with a first portion thermally coupled to the first heat exchanger and a second portion thermally coupled to the second heat exchanger. The electricity generation component is positioned to receive at least a portion of the heat received at the first heat exchanger and generate an electrical output using the received heat. To recycle unused heat from the power cell, the second heat exchanger can be thermally coupleable to a third heat exchanger in a residential heating appliance.

### CROSS-REFERENCE TO RELATED APPLICATION(S)

This application claims priority to U.S. Provisional Patent Application No. 63/093,158, filed on Oct. 16, 2020, U.S. Provisional Patent Application No. 63/128,866, filed on Dec. 22, 2020, and U.S. Provisional Patent Application No. 63/224,074, filed on Jul. 21, 2021, the entireties of which are incorporated herein by reference.

### TECHNICAL FIELD

The present technology is generally related to thermodynamic systems and methods for combined heat and power generation. In particular, the present technology relates to power cells and heat transfer systems for use within a residential heating appliance to generate power in conjunction with supplying heat to the residential heating appliance.

### BACKGROUND

Combined heat and power (“CHP”) systems, sometimes also referred to as co-generation systems, can generate both heat and electrical power in the same device and/or location. Typically, a fuel is combusted to generate heat for a local electrical power generator, then unused heat (e.g., excess or waste heat) from the local electrical power generator is delivered to another device (e.g., a heating appliance). One result of the secondary use for the unused heat is a higher combined efficiency than separate electrical power and heat generation. Because of the improvement in overall efficiency, CHP systems can offer decreased carbon emissions and produce energy cost savings.

Small scale CHP systems, sometimes also referred to as micro-CHP systems, typically produce less than approximately 50 kilowatts (kW) of electricity. Small scale CHP systems face challenges from both limitations in available technology and economic feasibility. For example, to be widely adopted, small scale CHP systems must meet low capital cost demands; maintain a low noise emission; require little to no maintenance for long periods of time; ramp on and off quickly to follow usage loads (e.g., during morning and evening hours in a residential environment); maintain competitive efficiencies at small scales; and be integrable with a wide range of residential heating and cooling appliances, such as various furnaces (for heating air), boilers/water heaters (for heating water), and/or absorption chillers (for providing cooling). The foregoing appliances are sometimes referred to collectively as “heating units,” “cooling units” and/or “heating or cooling units” or “residential heating appliances,” “residential cooling appliances” and/or “residential heating or cooling appliances.” Another unique challenge with small scale CHP systems, in particular those used in residential applications, is the limited space available for the heat-to-electricity converters. These challenges are especially difficult to meet at power levels at the scale of a residential household. As a result, despite the vast majority of households in North America and Europe having relatively low energy demands (e.g., on the scale of 1 kilowatt or less), small scale CHP systems have not been widely adopted.

### BRIEF DESCRIPTION OF THE DRAWINGS

FIG. 1 is a block diagram of a combined heat and power system configured for use with a residential heating appliance in accordance with some embodiments of the present technology.

FIG. 2 is a block diagram of a combined heat and power system configured for use with a residential heating appliance in accordance with further embodiments of the present technology.

FIGS. 3-8 are schematic diagrams of the thermal coupling arrangements between various combustion components and heat exchangers in accordance with various embodiments of the present technology.

FIGS. 9A and 9B are partially schematic diagrams of the thermal coupling between a reverse swiss roll burner and a heat exchanger in accordance with some embodiments of the present technology.

FIGS. 10A and 10B are schematic diagrams of a combined heat and power system positioned at least partially within a residential heating appliance in accordance with some embodiments of the present technology.

FIG. 11 is a schematic diagram of a combined heat and power system positioned at least partially within a residential heating appliance of the type shown in FIGS. 10A and 10B, in accordance with some embodiments of the present technology.

FIG. 12 is a schematic diagram of a combined heat and power system positioned at least partially within a residential heating appliance of the type shown in FIGS. 10A and 10B, in accordance with some embodiments of the present technology.

FIG. 13 is a partially schematic cross-sectional view of a combustion component and power cell in accordance with some embodiments of the present technology.

FIGS. 14-19 are schematic diagrams of various combined heat and power systems positioned at least partially within a residential heating appliance in accordance with some embodiments of the present technology.

FIGS. 20A and 20B are a schematic diagram and a partially schematic cross-sectional view, respectively, of a recuperator for a CHP system configured in accordance with some embodiments of the present technology.

FIG. 21 is a schematic diagram of a combined heat and power system with a combustion component having multiple burners in accordance with some embodiments of the present technology.

FIG. 22 is a partially schematic cross-sectional view of the thermal coupling between a heat exchanger of a power cell and a heat exchanger of a residential heating appliance in accordance with further embodiments of the present technology.

FIG. 23 is a schematic diagram of a combined heat and power system configured for use with a residential heating appliance in accordance with further embodiments of the present technology.

The figures have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

For ease of reference, the CHP systems disclosed herein, and components thereof, are sometimes described herein with reference to top and bottom, upper and lower, upwards and downwards, and/or longitudinal directions relative to the spatial orientation of the embodiments shown in the figures. It is to be understood, however, that the CHP systems and their components can be moved to, and used in, different spatial orientations without changing the structure and/or function of the disclosed embodiments of the present technology.

### DETAILED DESCRIPTION

### Overview

Combined heat and power (CHP) systems and related methods are disclosed herein. In some embodiments, the CHP system can work in two modes. A first mode is a heat-following mode, in which generating heat is the primary function of the CHP system. As a secondary function, electricity is produced by diverting some of the heat into the production of electricity. In the first mode, the utilization rate of the electricity generator (e.g., the time the electricity generator takes to use heat to generate electricity and direct waste heat onward) is a key impact in the utility of the CHP system. In particular, faster utilization rates are important to ensure that the electricity generation does not delay the production of heat. This can be especially important in small scale systems (e.g., in a residential environment), where the demand for heat can quickly ramp up or down at different times of the day, preventing the CHP system from being run continuously to meet demand for heat through an uninterrupted flow. The second mode is an electricity-following mode. In the electricity-following mode, the principle function of the CHP system is to produce electricity while the heat produced in the process of generating the electricity is captured for another useful purpose, such as heating water or providing heat for a secondary process.

In a residential application, a CHP system as disclosed herein is primarily operated in the first mode to follow the heat demand in a residential unit. In this mode, the CHP system can generate enough electricity to fully power itself and/or the residential heating appliance it is attached to. This operation allows the CHP system and the residential heating appliances to be resilient against a loss in power (e.g., due to a blackout). Additionally, or alternatively, this operation also allows the CHP system to export power into a local power grid or a broader power grid during periods of low demand for heat from the CHP system and/or the residential heating appliance. Exporting power locally allows the CHP system to at least partially offset a user's power consumption within the residential unit. Exporting power into a broader electric grid allows the CHP system to generate compensation for the user and/or at least partially offset the power consumption in the broader electric grid. It will be understood, however, that a CHP system as disclosed herein can be adapted to operate in the second mode to increase electricity production, and then direct any unused heat to the residential heating appliances in a residential unit. In such embodiments, the CHP system can further offset the power consumption in the residential unit and/or export additional power into a broader electric grid.

In some embodiments, the CHP system includes a combustion component and a power cell. The combustion component can be operably coupleable to one or more inputs to receive a fuel (e.g., a hydrocarbon fuel, pure hydrogen fuel, and/or the like) and an oxidant (e.g., an oxygen-carrying agent, such as air, compressed air, oxygen gas, and/or any other suitable oxygen-carrying compound) for combustion within the combustion component while the power cell is operably coupled to the combustion component. For example, the power cell can include a first heat exchanger (e.g., a hot-side heat exchanger) thermally coupled to the combustion component to receive heat from the combustion of the fuel with the oxidant. The power cell can also include a second heat exchanger (e.g., a cold-side heat exchanger) and an electricity generation component with a first portion thermally coupled to the first heat exchanger and a second portion thermally coupled to the second heat exchanger. Accordingly, the electricity generation component (e.g., one or more of a thermionic energy converter, thermoelectric energy converter, alkali metal thermal-to-electricity converter, and/or the like) is positioned to receive at least a portion of the heat received at the first heat exchanger and generate an electrical output using the received heat. Received heat that is not converted into electricity (unused heat) can then flow from the electricity generation component to the second heat exchanger. To recycle the unused heat from the power cell, the second heat exchanger can be thermally coupleable to a third heat exchanger in a residential heating or cooling appliance (e.g., a gas furnace, hot water boiler, steam boiler, water heater, absorption chiller, heat pump, and/or the like).

In some embodiments, the CHP system also includes a recuperator operably coupleable to the combustion component and at least one of the one or more inputs to recycle a portion of the unused heat from the power cell. For example, the recuperator can receive a portion of the unused heat from the power cell and transfer it to the oxidant flowing into the combustion component. By preheating the oxidant before the combustion, the recuperator can increase the efficiency of the combustion process, thereby increasing the amount of heat released from the combustion that is available for use by the power cell. In some embodiments, the increased efficiency allows the combustion component to use less fuel while providing the same amount of heat to the power cell. In some embodiments, the increased efficiency allows the combustion component to provide more heat to the power cell, thereby increasing the electrical output.

In some embodiments the CHP system includes a valve operably coupleable to the combustion component and the residential heat exchanger. The valve has a first position in which it allows at least a portion of the flue gas from the combustion process to bypass the power cell and flow to the third heat exchanger, as well as a second position in which the valve prevents the portion of the flue gas from bypassing the power cell. When the valve is in the first position, at least a portion of the heat from the combustion can be transported to the residential heat exchanger via the portion of the flue gas that bypasses the power cell. In some embodiments, the CHP system can set the valve in the first position during a ramp up period to immediately meet a demand for heat while the power cell heats up. In some embodiments, the CHP system can set the valve in the first position during a period of high heat demand to fully meet the demand.

### Suitable Combined Heat and Power Systems

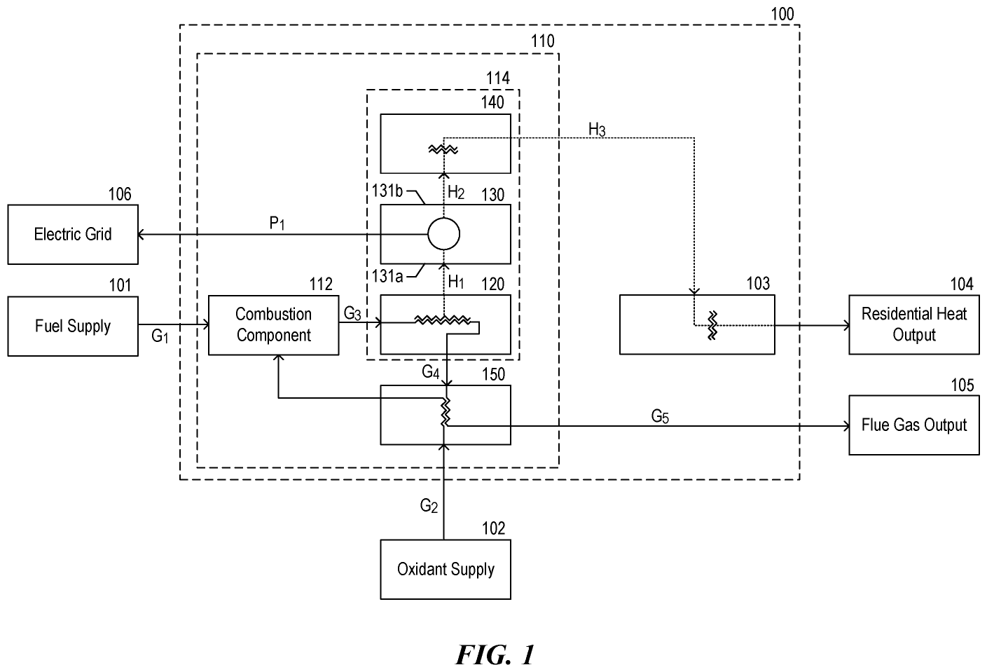

FIG. 1 is a block diagram of a combined heat and power system 110 configured for use with a residential heating appliance 100 in accordance with some embodiments of the present technology. In the illustrated embodiment, the combined heat and power system 110 (“CHP system 110,” sometimes also referred to herein as a “co-generation system”) includes a combustion component 112 and a power cell 114 (sometimes also referred to herein as a “heat cell,” and/or a “power generation module”). The power cell 114 includes a first heat exchanger 120 (e.g., a hot-side heat exchanger) that is thermally coupled to the combustion component 112, a second heat exchanger 140 (e.g., a cold-side heat exchanger), and an electricity generation component 130 thermally coupled to the first and second heat exchangers 120, 140, as indicated by first and second heat paths H₁, H₂ in dashed lines.

As illustrated in FIG. 1 the combustion component 112 (e.g., a burner, burner system, plurality of burners, reactor, ignitor, and/or the like) is operably coupleable to a fuel supply 101 (e.g., a natural gas input, a hydrogen gas input, and/or the like) via a first gas flow path G₁ (shown by a solid line) and an oxidant supply 102 (e.g., from an air pump input, oxygen tank input, and/or the like) via a second gas flow path G₂. In various embodiments, the fuel can be any of a variety of suitable hydrocarbon gases or fluids, such as natural gas, methane gas, fuel oil, coal, liquefied petroleum gas, and/or the like, and/or a pure hydrogen gas. The oxidant can be any suitable oxygen-carrying agent such as air, compressed air, oxygen gas, and/or any other suitable oxygen-carrying compound. The combustion component 112, or a separate mixer (not shown), receives and mixes the fuel and the oxidant. In some embodiments, the mixture includes a stoichiometric ratio (e.g., a theoretical ideal ratio for complete, efficient combustion) of the fuel with the oxygen carried by the oxidant. Purely by way of example, the stoichiometric ratio, by mass, of air to natural gas is about 17.2 to 1 (e.g., requiring about 17.2 kg of air to completely and efficiently burn 1 kg of natural gas). In some embodiments, the mixture is within about 10 percent of the stoichiometric ratio, within about 5 percent of the stoichiometric ratio, within about 1 percent of the stoichiometric ratio, or within about 0.1 of the stoichiometric ratio. Purely by way of another example, for a mixture within about ten percent of the stoichiometric ratio of air to natural gas, the mixture can have an actual ratio of air to natural gas of between about 15.48 to 1 and about 18.92 to 1.

The combustion component 112 can then combust the mixture, resulting in a flue gas that is directed to the power cell 114 via a third flow path G₃. Heat from the flue gas can be transferred to the power cell 114 via the first heat exchanger 120 by conduction (e.g., based on contact between the flue gas and the first heat exchanger 120) and/or radiation (e.g., through heat radiation from an intermediate substrate adjacent the first heat exchanger 120). The flue gas then flows out of the power cell 114 along a fourth flow path G₄ while heat flows out of the first heat exchanger 120 and into the electricity generation component 130 along a first heat path H₁.

In some embodiments, the combustion component 112 replaces the burner previously used in the residential heating appliance 100 to increase the combustion temperature, while consuming the same type of fuel (e.g., by (1) increasing a pressure of the fuel and oxidant before combustion, (2) altering a ratio of the fuel to the oxygen in the oxidant, and/or (3) increasing the amount of fuel consumed in the combustion. For example, in some embodiments, the combustion temperature in the combustion component 112 can be between about 1200 degrees Celsius (° C.) and about 2500° C., or about 2000° C. The increase in combustion temperature allows the electricity generation component 130, discussed in more detail below, to more efficiently generate an electrical output. Further, the increase in combustion temperature can help ensure that the CHP system 110 outputs enough unused heat to the residential heating appliance 100 to meet heating demands.

The electricity generation component 130 has a first portion 131a thermally coupled to the first heat exchanger 120 to receive the heat along the first heat path H₁ and a second portion 131b coupled to the second heat exchanger 140 along a second heat path H₂. As the first heat exchanger 120 receives heat from the combustion process via the flue gas, the first heat exchanger 120 rises in temperature. As the first heat exchanger 120 rises in temperature, the first portion 131a of the electricity generation component 130 rises in temperature as well, thereby creating a temperature difference between the first portion 131a and the second portion 131b. The electricity generation component 130 can then use the temperature difference to generate an electrical output as heat flows from the first portion to the second portion. As illustrated in FIG. 1, the electricity generation component 130 then directs the electrical output along a power line P₁ into an electric grid 106 external and/or coupled to the CHP system 110. In various embodiments, the electric grid 106 include a battery connected to the CHP system 110 and/or the residential heating appliance 100, a local power grid (e.g., a residential power grid, an apartment power grid, a neighborhood power grid, a commercial power grid, and/or the like), and/or a broader power grid (e.g., a city-wide grid, county-wide grid, state-wide grid, and/or the like).

In various embodiments, the electricity generation component 130 can include thermionic energy converters, thermoelectric energy converters (sometimes also called thermoelectric energy converters), thermoacoustic energy converters, and/or alkali metal thermal-to-electricity converters. In such embodiments, the electricity generation component 130 generates electricity without any moving physical components, thereby requiring little (or no) maintenance, even when operating continuously (or nearly continuously).

The electrical output from the electricity generation component 130 can be between about 0.01 kilowatts (kW) and about 50 kW, between about 0.05 kW and about 5 kW, between about 0.1 kW and about 1 kW, or about 0.5 kW. In a specific, non-limiting example, the electrical output from the electricity generation component 130 can be between about 0.09 kW and about 0.3 kW to ensure that the CHP system 110 can fully power a furnace (e.g., the residential heating appliance 100) as well as all of the related electrical components (e.g., a thermostat, gas pumps, and the like). In various embodiments, the electric grid 106 can use the electrical output from the electricity generation component 130 to at least partially power (1) one or more devices related to the fuel and oxidant supply 101, 102 (e.g., pumps, meters, and/or the like); (2) various components of the residential heating appliance 100 (e.g., a controller, processor, pumps, fans, vents, valves, and/or the like); and/or (3) various components of the CHP system 110 (e.g., to start combustion within the combustion component 112); to offset power consumption on a local power grid (e.g., within a residential unit); and/or to export power into a broader power grid. In a particular example, the electrical output is sufficient to power both the residential heating appliance 100, the CHP system 110, and any related devices, thereby allowing the residential heating appliance 100 and the CHP system 110 to be self-sufficient. In such embodiments, the electrical output from electricity generation component 130 allows the residential heating appliance 100 and the CHP system 110 to be operated even when external electrical power is unavailable (e.g., during a blackout).

As further illustrated in FIG. 1, the unused heat from the electricity generation component 130 (sometimes also referred herein to as “waste heat” and/or “excess heat”) flows out of the electricity generation component 130 and into the second heat exchanger 140 along the second heat path H₂. In turn, the second heat exchanger 140 can be thermally coupled to a third heat exchanger 103 within the residential heating appliance 100 to direct heat to the third heat exchanger 103 along a third heat flow path H₃. As a result, heat that the power cell 114 does not convert into electricity can be used for residential heating purposes, such as boiling water, heating water, heating air within a furnace, and/or the like. Purely by way of example, as discussed in more detail below, the third heat exchanger 103 can include the water coils of a coiled tube boiler that are in thermal communication with the second heat exchanger 140 (e.g., through contact, one or more thermal connections, convection channels, thermal radiation, and/or the like). The heat transferred into the third heat exchanger 103 is then used by the residential heating appliance 100 and directed into a residential heat output 104 (e.g., hot water pipes, air duct system, and/or the like).

It will be understood by one of skill in the art that, in some embodiments, one or more of the heat exchangers described above can be combined into a single heat exchanger. By way of example only, the second and third heat exchanges 140, 103 described above can be combined in a single heat exchanger that transfers heat from the cold side of the energy converter directly to a fluid used in the residential heating appliance 100 (e.g., air (in the case of a furnace) and/or water (in the case of a boiler)).

As discussed above, the combustion component 112 of the CHP system 110 combusts the fuel with the oxygen at a relatively high temperature compared to a typical operating temperature for the residential heating appliance 100. As discussed above, to increase the combustion temperature, the combustion component 112 can increase the pressure of the fuel and oxidant before the combustion, alter the ratio of the fuel to the oxygen that is combusted, and/or increase the amount of fuel consumed in the combustion. As a result, the unused heat flowing out of the power cell 114 and into the third heat exchanger 103 can be sufficient (or more than sufficient) to operate the residential heating appliance 100. In addition, as discussed above, the CHP system 110 can use the same inputs as the residential heating appliance 100. That is, the CHP system 110 relies on the same inputs as a previous heating system while both generating an electrical output and providing an operable level of input heat to the residential heating appliance 100. Accordingly, the CHP system 110 can reduce the carbon footprint of a residential unit, reduce power consumption in the residential unit, and protect against losses of power, all while requiring minimal modifications to an existing residential heating system.

As further illustrated in FIG. 1, the CHP system 110 can also include a recuperator 150 positioned to receive the flue gas downstream from the first heat exchanger 120. For example, after transferring heat into the first heat exchanger 120, the flue gas can flow out of the power cell 114 via the fourth flow path G₄ and into the recuperator 150. As the flue gas flows through the recuperator 150, a portion of unused heat (e.g., heat that was not given up at the first heat exchanger 120) is transferred to oxidant entering the combustion component 112. For example, as illustrated in FIG. 1, the recuperator 150 can be operably coupled between the combustion component 112 and the oxidant supply 102 via the second input line G₂. As the oxidant passes through the recuperator 150, it receives the unused heat received from the flue gas. That is, the recuperator 150 can recycle a portion of the unused heat to pre-heat the oxidant flowing into the combustion component 112. In turn, the preheated oxidant requires less input energy to combust with the fuel, thereby improving the efficiency of the combustion component 112. As a result, by recycling the unused heat from the power cell 114, the recuperator 150 can increase the efficiency of the CHP system 110 overall. After transferring heat to the oxidant, the flue gas can flow out of the recuperator 150 and out of the CHP system 110 along a fifth flow path G₅ to a flue gas output 105 (e.g., a duct system, chimney, and/or the like).

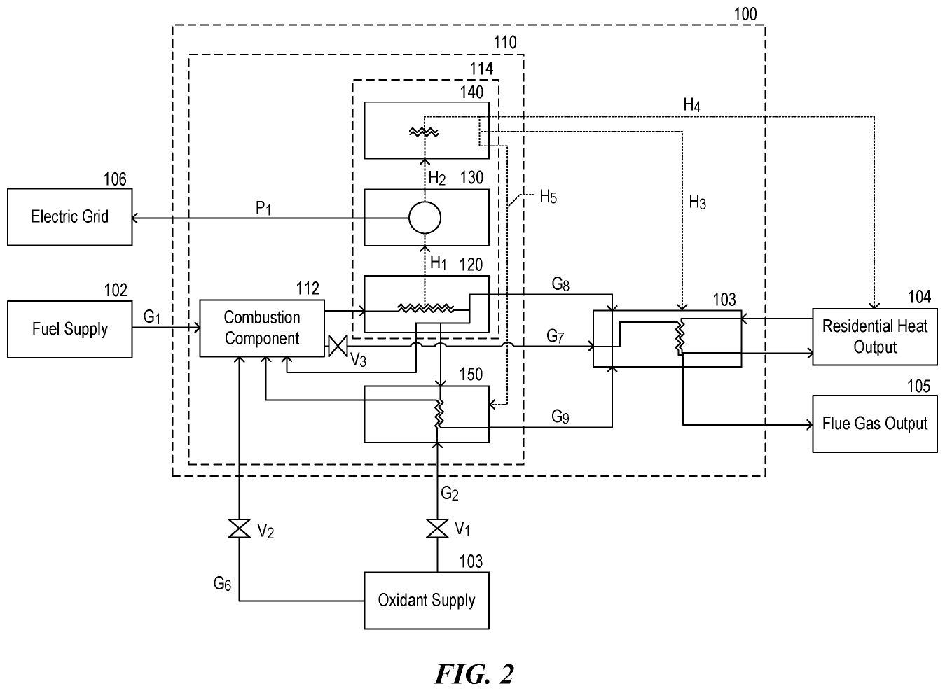

FIG. 2 is a block diagram of a CHP system 110 of the type shown in FIG. 1, configured for use with the residential heating appliance 100 in accordance with further embodiments of the present technology. In the illustrated embodiment, the CHP system 110 includes various (optional) additional gas flow paths and heat paths.

For example, as illustrated in FIG. 2, the CHP system 110 can include a first valve V₁ and a second valve V₂, each of which can be operably coupled to the oxidant supply 102. The first valve V₁ can control the flow of the oxidant along the second gas flow path G₂ to allow, prevent, and/or modulate a rate of the oxidant flowing through the recuperator 150. The second valve V₂ can control the flow of the oxidant along a sixth gas flow path G₆ that does not enter the recuperator 150 before entering the combustion component 112 to allow, prevent, and/or modulate a rate of the oxidant that is not preheated by the recuperator 150. For example, the first and second valves V₁, V₂ can operate in conjunction to direct the oxidant into the combustion component 112, without being preheated during a ramp-up phase for the CHP system 110 (e.g., when the CHP system 110 is first turned on). The first and second valves V₁, V₂ can then (a) begin directing the oxidant through the recuperator 150 as the recuperator 150 begins receiving heat from the flue gas, and (b) increase the percentage of the oxidant that is directed through the recuperator 150 over time.

Additionally, or alternatively, the CHP system 110 can include a third valve V₃ operably coupled to the combustion component 112 and the third heat exchanger 103. The third valve V₃ can control the flow of a portion of the flue gas from the combustion to allow, prevent, and/or modulate the flue gas flow rate from the combustion component 112 and the third heat exchanger 103 along a seventh gas flow path G₇ that bypasses the power cell 114. As a result, the third valve V₃ can allow the CHP system 110 to transfer heat between the combustion component 112 and the third heat exchanger 103 without flowing through the power cell 114 first. The CHP system 110 can position the third valve V₃ in an open position during the ramp-up phase for the CHP system 110 (e.g., when the CHP system 110 is first turned on) to more quickly meet a demand at the residential heating appliance 100, and/or during a period of high demand for the residential heating appliance 100.

As further illustrated in FIG. 2, the first heat exchanger 120 and the third heat exchanger 103 can be operably coupled to allow the first heat exchanger 120 to direct a portion of the flue gas along an eighth gas flow path G₈ to the third heat exchanger 103 (e.g., instead of to the recuperator 150). In doing so, the CHP system 110 can transfer heat to the third heat exchanger 103 in a manner that bypasses the elements of the power cell 114. Accordingly, the eighth gas flow path G₈ can transfer heat to the third heat exchanger 103 more quickly than the third heat flow path H₃ because the heat does not need to flow through the remaining components in the power cell 114 before arriving at the third heat exchanger 103. Accordingly, the CHP system 110 can direct flue gas along the eighth gas flow path G₈ during the ramp-up phase for the CHP system 110 (e.g., when the CHP system 110 is first turned on) to more quickly meet a demand at the residential heating appliance 100 and/or during a period of high demand for the residential heating appliance 100.

Similarly, the recuperator 150 and the third heat exchanger 103 can be operably coupled to allow the first heat exchanger 120 to direct a portion of the flue gas along a ninth gas flow path G₉ to the third heat exchanger 103 (e.g., instead of to the flue gas output 105). In doing so, the CHP system 110 can transfer heat to the third heat exchanger 103 from an additional source (e.g., the flue gas). In some embodiments, the ninth gas flow path G₉ can transfer heat to the third heat exchanger 103 more quickly than the third heat flow path H₃ because the heat does not need to flow through the remaining components in the power cell 114 before being delivered. Accordingly, the CHP system 110 can direct flue gas along the ninth gas flow path G₉ during the ramp up phase for the CHP system 110 (e.g., when the CHP system 110 is first turned on) to more quickly meet a demand at the residential heating appliance 100 and/or during a period of high demand for the residential heating appliance 100.

As further illustrated in FIG. 2, the second heat exchanger 140 can be thermally coupled to the residential heat output 104 to transfer a portion of the unused heat along a fourth heat path H₄. As illustrated in FIG. 2, the fourth heat path H₄ can transfer heat from the electricity generation component 130 to the residential heat output 104 without going through the third heat exchanger 103. In a particular example, the residential heating appliance 100 can be a furnace connected to an air duct system for the residential heat output 104. In such embodiments, the second heat exchanger 140 can have an exposed surface to direct heat into air circulating through the air duct system, rather than requiring the heat to be transferred through the third heat exchanger 103.

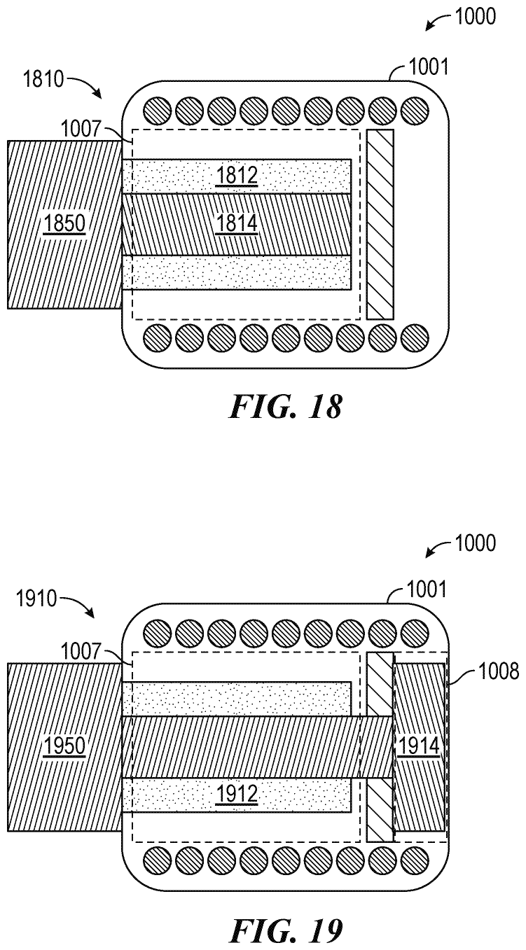

Additionally, or alternatively, the second heat exchanger 140 can be thermally coupled to the recuperator 150 to transfer a portion of the unused heat from the electricity generation component 130 into the recuperator 150 along a fifth heat path H₅. For example, a portion of the second heat exchanger 140 can be in contact with a portion of the recuperator 150, allowing heat to conduct out of the second heat exchanger 140 and into the recuperator 150, a specific example of which is discussed below with respect to FIG. 18. In such embodiments, similar to the preheating process discussed above, the recuperator 150 can receive and use the unused heat to help preheat the oxidant. As a result, the recuperator 150 can increase the overall efficiency of the power cell 114.

It will be understood that while several additional gas and heat flow paths (compared to FIG. 1) have been discussed and illustrated in combination in FIG. 2, the CHP system 110 can include any subset (including all) of the additional gas and heat flow paths. Purely by way of example, the CHP system 110 can include only the third valve V₃ and the seventh gas flow path G₇ in addition to the gas and heat flow paths discussed above with reference to FIG. 1. In another example, the CHP system 110 can include the first and second valves V₁, V₂, the sixth gas flow path G₆, and the fifth heat path H₅ in addition to the gas and heat flow paths discussed above with reference to FIG. 1. In yet another example, the CHP system 110 can include the first-third valves V₁-V₃, the sixth gas flow path G₆, and the seventh gas flow path G₇ in addition to the gas and heat flow paths discussed above with reference to FIG. 1.

### Examples of Suitable Thermal Coupling Between the Combustion Component and the Power Cell

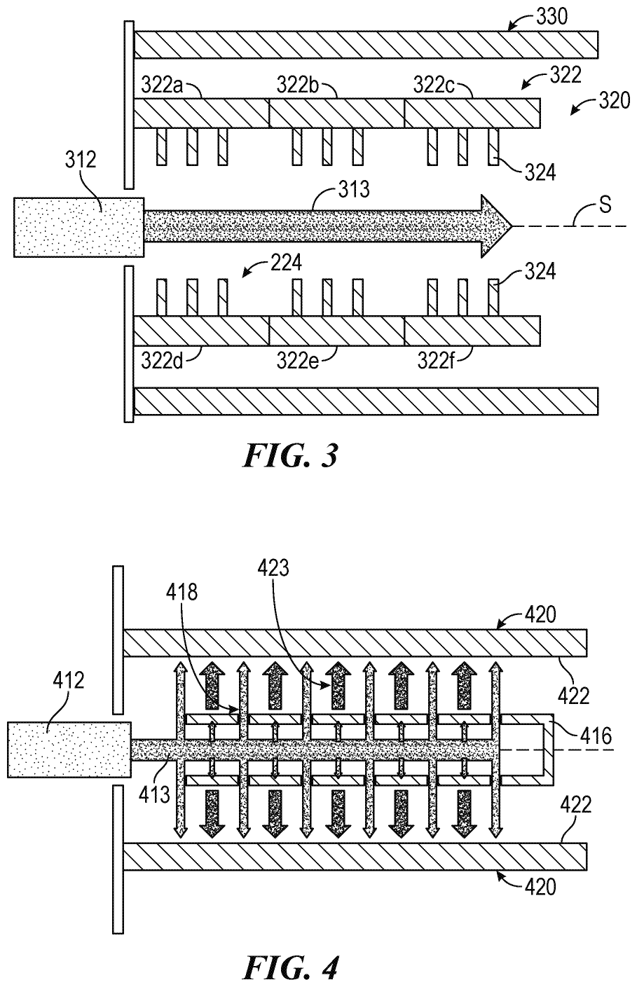

FIGS. 3-8 are schematic diagrams of the thermal coupling arrangements between various combustion components and power cells in accordance with various embodiments of the present technology. It will be understood that any of the thermal couplings discussed with respect to FIGS. 3-8 can be included in the CHP system 110 discussed above with respect to FIGS. 1 and 2 to increase the amount of heat transferred between the combustion component 112 and the first heat exchanger 120.

In each of the illustrated embodiments, the thermal coupling between the combustion components and power cells includes an axis of symmetry S about which the components of the combustion components and power cells are mirrored and/or rotated. However, it will be understood that, in some embodiments, no such axis of symmetry exists and that the components of each embodiment can be moved and/or altered in any way consistent with the descriptions below.

FIG. 3 illustrates the thermal coupling between a combustion component 312 and a first heat exchanger 320 in accordance with some embodiments of the present technology. In the illustrated embodiment, the first heat exchanger 320 is positioned in a flow path of flue gas 313 emitted from the combustion component 312. Interactions between the flue gas 313 and the first heat exchanger 320 result in conduction of heat from the flue gas 313 into the first heat exchanger 320. Further, the first heat exchanger 320 includes a plurality of heat transfer elements 322 (six shown, referred to individually as first-sixth heat transfer elements 322a-322f) each having one or more protrusions 324. The protrusions 324 have a geometric shape that extends into and/or disrupts the flow path of the flue gas 313. Accordingly, the protrusions 324 cause turbulence in the flow path of the flue gas 313, which in turn causes the flue gas 313 to have an increased heat flux with each of the plurality of heat transfer elements 322. As a result, the flue gas 312 can transfer a larger amount of heat into each of the plurality of heat transfer elements 322.

In the illustrated embodiment, the protrusions 324 are illustrated as orthogonal to the flow path of the flue gas 313. However, in various other embodiments, the protrusions 324 can be oriented at other angles, e.g., acute, obtuse, and/or parallel with the flow path. Purely by way of example, the protrusions 324 can positioned parallel to the flow path but with non-uniform spacing and\or heights that cause turbulence in the flow path of the flue gas 313.

As discussed above, the first heat exchanger 320 includes an axis of symmetry S about which the components of the first heat exchanger 320 (e.g., the heat transfer elements 322 and the protrusions 324) are mirrored. That is, the first-third heat transfer elements 322a-322c and their protrusions 324 are similar (or identical) to the fourth-sixth heat transfer elements 322d-322f. In various other embodiments, the first heat exchanger 320 can include various other axes of symmetry and/or can have no axis of symmetry. For example, in some embodiments, each of the first-sixth heat transfer elements 322a-322f and their protrusions 324 are different from the others.

In some embodiments, each of the first-sixth heat transfer elements 322a-322f is thermally coupled to a single electricity generation component 130 (FIG. 1) in parallel. In some embodiments, a first subset of the first-sixth heat transfer elements 322a-322f is thermally coupled to a first electricity generation component while a second subset of the first-sixth heat transfer elements 322a-322f is thermally coupled to a second electricity generation component. In some embodiments, each of the first-sixth heat transfer elements 322a-322f is thermally coupled to an independent electricity generation component.

FIG. 4 illustrates the thermal coupling between a combustion component 412 that includes an intermediate substrate 416 and a first heat exchanger 420 in accordance with further embodiments of the present technology. The intermediate substrate 416 is positioned in the flow path of the flue gas 413 and adjacent the first heat exchanger 420, forcing the flue gas 413 to travel through the intermediate substrate 416 before contacting the first heat exchanger 420. As the intermediate substrate 416 rises in temperature, the intermediate substrate 416 radiates heat toward a heat transfer element 422 of the first heat exchanger 420 (arrows 423). That is, the intermediate substrate 416 is able to absorb heat from the flue gas 413, then radiate the absorbed heat toward the heat transfer element 422. To maximize the heat transferred to the first heat exchanger 420, the intermediate substrate 416 can include a relatively conductive, radiative material (e.g., materials approaching black-body radiators, conductive metals such as copper and/or iron, and/or the like).

As further illustrated in FIG. 4, the intermediate substrate 416 can include one or more perforations 418 (e.g., holes) oriented toward the first heat exchanger 420 to direct the flue gas 413 into contact with the heat transfer element 422. As a result, the intermediate substrate 416 can increase the heat transferred into the first heat exchanger 420 by increasing the contact between the flue gas 413 and the heat transfer element 422, and therefore the heat conduction between the two. In such embodiments, the heat transfer element 422 can simultaneously absorb heat from the intermediate substrate 416 (e.g., through the radiation) and the flue gas 413 (e.g., through conduction), thereby increasing the heat transferred into the first heat exchanger 420.

In a specific, non-limiting example, the intermediate substrate 416 can include a cylinder-shaped body that is positioned in fluid communication with a combustion region of the combustion component 410 to receive the flue gas 413 from the combustion before the first heat exchanger 420. Further, the body of the intermediate substrate 416 can include a highly conductive metal (e.g., copper and/or iron). As a result of the positioning and composition of the intermediate substrate 416, the intermediate substrate 416 can absorb a large amount of heat from the flue gas 413, then radiate the absorbed heat toward the first heat exchanger 420. Further, the body of the intermediate substrate 416 can include the perforations 418 to direct the flue gas 413 toward the first heat exchanger 420. As a result, the first heat exchanger 420 can also absorb additional heat from the flue gas 413 through conduction.

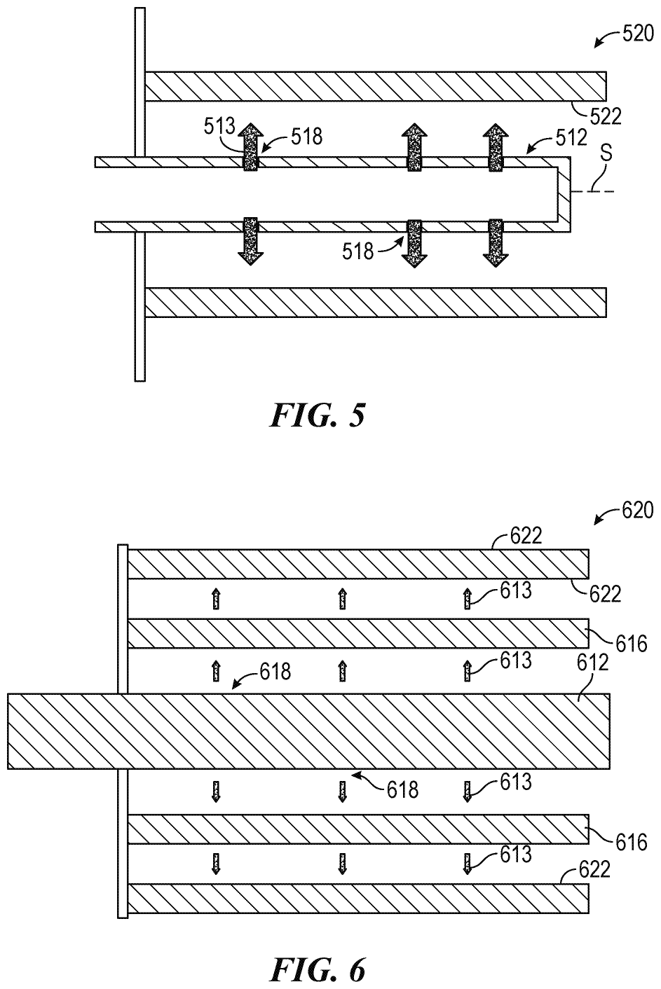

FIG. 5 illustrates the thermal coupling between a combustion component 512 and a first heat exchanger 520 in accordance with further embodiments of the present technology. In the illustrated embodiment, the combustion component 512 includes outlets 518 oriented to direct flue gas 513 into contact with a heat transfer element 522 of the first heat exchanger 520. Accordingly, the orientation of the outlets 518 can increase the amount of interaction between the flue gas 513 and the heat transfer element 522. As a result, the orientation of the outlets 518 can increase the amount of heat transferred through conduction between the flue gas 513 and the heat transfer element 522.

In the illustrated embodiment, the heat transfer element 522 at least partially surrounds the combustion component 512 along a longitudinal axis and the outlets 518 are oriented to direct the flue gas 513 orthogonal to the longitudinal axis. In various other embodiments, the heat transfer element 522 can be positioned in other locations relative to the combustion component 512 and/or the outlets 518 can be oriented differently. Purely by way of example, the heat transfer element 522 can be positioned only partially surrounding the combustion component 512 along the longitudinal axis while the outlets 518 are at a 45 degree angle with respect to the longitudinal axis to help direct a flow of the flue gas 513 away from the first heat exchanger 520 after contact.

FIG. 6 illustrates the thermal coupling between a combustion component 612 and a first heat exchanger 620 in accordance with further embodiments of the present technology. Similar to the thermal coupling discussed above with respect to FIG. 5, the first heat exchanger 620 includes a heat transfer element 622 positioned to at least partially surround the combustion component 612. Further, the combustion component 612 includes outlets 618 oriented to direct flue gas 613 toward the heat transfer element 622. However, in the illustrated embodiment, the combustion component 612 also includes an intermediate substrate 616 between the outlets 618 and the heat transfer element 622. Similar to the intermediate substrate 416 discussed above with respect to FIG. 4, the intermediate substrate 616 can absorb heat from the flue gas 613 through conductive interactions, then radiate the heat toward the heat transfer element 622. The flue gas 613 then passes through the intermediate substrate toward the heat transfer element 622 to interact with the heat transfer element. The heat transfer element 622 can simultaneously absorb heat from the flue gas 613 and the intermediate substrate 616. Accordingly, the intermediate substrate 616 can increase the amount of heat absorbed from the flue gas 613 overall (e.g., by effectively increasing the surface area of material absorbing heat from the flue gas 613).

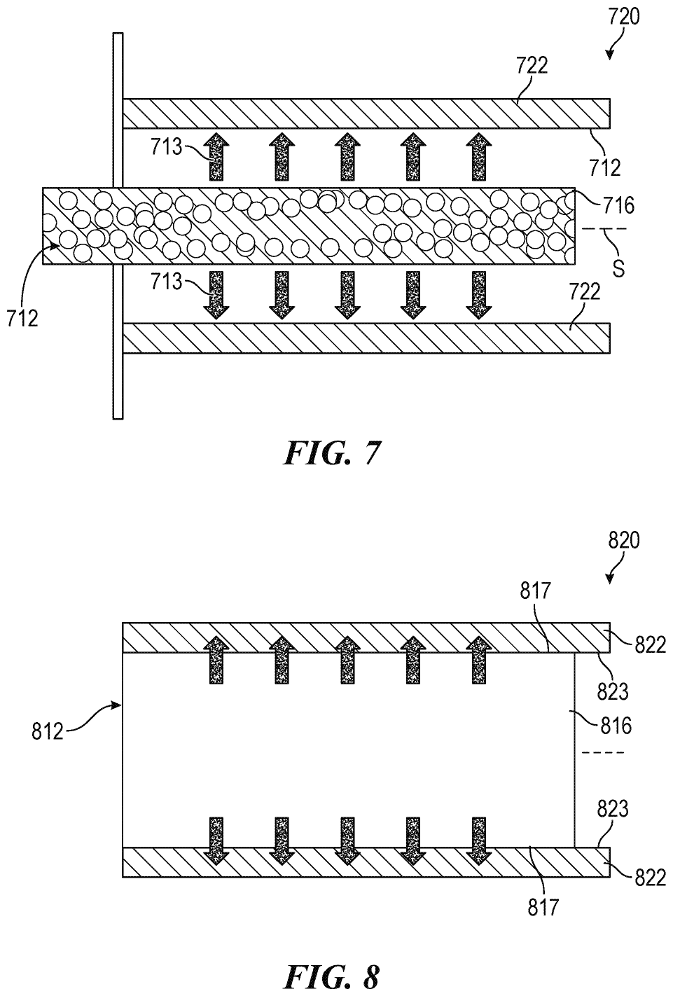

FIG. 7 illustrates the thermal coupling between a combustion component 712 and a first heat exchanger 720 in accordance with further embodiments of the present technology. Similar to the thermal coupling discussed above with respect to FIG. 5, the first heat exchanger 720 includes a heat transfer element 722 positioned to at least partially surround the combustion component 712. Further, in the illustrated embodiment, the combustion component 712 includes a porous burner 716. The porous burner 716 can act as both a heat radiating substrate and an outlet that directs flue gas 713 toward the heat transfer element 722. That is, as combustion occurs within the porous burner 716, the porous burner 716 absorbs heat from the combustion and rises in temperature. As the porous burner 716 rises in temperature, it radiates heat toward the first heat exchanger 720. The radiated heat can then be absorbed by the heat transfer element 722.

Meanwhile, the channels in the porous burner 716 direct the flue gas 713 out of the combustion component 712 toward the heat transfer element 722. In some embodiments, the outlets of the porous burner 716 are randomly organized and/or oriented, such that the outlets cause turbulence in the flow path of flue gas 713. As a result, the porous burner 716 can increase the heat flux between the flue gas 713 and the heat transfer element 722, thereby increasing the amount of heat absorbed by the heat transfer element 722 through conduction.

FIG. 8 illustrates the thermal coupling between a combustion component 812 and a first heat exchanger 820 in accordance with further embodiments of the present technology. The illustrated embodiment is generally similar to the embodiment discussed above with respect to FIG. 7. For example, the combustion component 812 includes a porous burner 816 (shown schematically) while the first heat exchanger 820 includes a heat transfer element 822 positioned to at least partially surround the combustion component 812. In the illustrated embodiment, however, an outer surface 817 of the porous burner 816 is in physical contact with an inner surface 823 of the heat transfer element 822. The physical contact between the porous burner 816 and the heat transfer element 822 allows the porous burner 816 to transfer heat into the heat transfer element 822 through conduction rather than radiation.

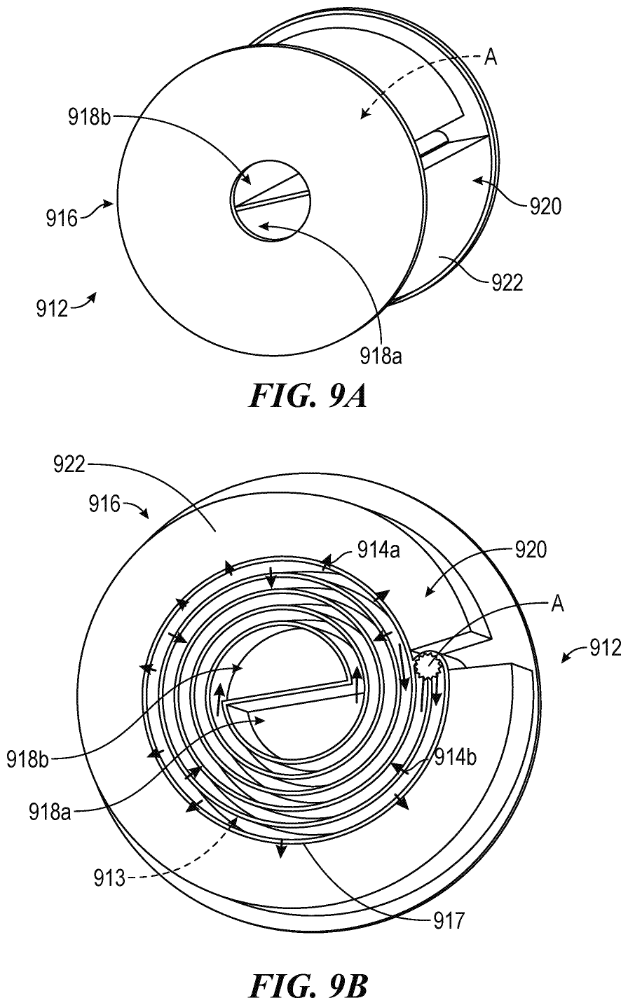

FIGS. 9A and 9B are partially schematic diagrams of the thermal coupling between a combustion component 912 and a heat exchanger 920 in accordance with some embodiments of the present technology. In the illustrated embodiment, the combustion component 912 includes a reverse swiss roll burner 916 that includes an input channel 918a and an outlet channel 918b separated from the input channel 918a by a combustion region A. As best illustrated in FIG. 9B, the combustion region A is approximately at the turning point for the reverse swiss roll burner 916, thereby causing combustion to occur near an outer surface 917 of the reverse swiss roll burner 916. During operation, a mixture of the fuel and the oxidant flow into the reverse swiss roll burner 916 along the input channel 918a, then combusts in the combustion region A. The resulting flue gas 913 flows then out of the reverse swiss roll burner 916 along the outlet channel 918b while transferring heat in two directions, as described below.

First, the flue gas 913 transfers heat through the outer surface 917 in a first direction (arrows 914a, FIG. 9B), especially during a first turn around the circumference of the reverse swiss roll burner 916. Accordingly, as illustrated in FIGS. 9A and 9B, the first heat exchanger 920 can include a heat transfer element 922 in contact with at least a portion of the outer surface 917. As heat flows out of the flue gas 913 in the first direction, the heat is conducted into the first heat exchanger 920 through the heat transfer element 922.

Second, the flue gas 913 transfers heat into the mixture in the input channel 918a in a second direction (arrows 914b, FIG. 9B). As a result, the reverse swiss roll burner 916 both combusts the mixture coming in and acts as a recuperator to preheat the mixture before combustion. Further, the relatively long travel path of outlet channel 918b provides a significant amount of contact area for the flue gas 913 to transfer heat into the mixture in the input channel 918a. As a result, the reverse swiss roll burner 916 can recycle a significant portion of the heat in the flue gas 913.

The inverse flow path of the reverse swiss roll burner 916 compared to a typical swiss roll burner helps transfer a large amount of heat to the heat transfer element 922 of the first heat exchanger 920 and/or helps increase the output power of the CHP system 110 (FIG. 1). For example, the inverse flow path allows the flue gas 913 to directly conduct heat into the heat transfer element 922 around the largest circumference of the reverse swiss roll burner 916, providing increased (e.g., maximum) time and surface area for the direct conduction to occur. As a result, the amount of heat drawn from the flue gas 913 is increased, thereby increasing the efficiency and/or output power of the CHP system 110 (FIG. 1). Further, because the first heat exchanger 920 is positioned around the outside of the reverse swiss roll burner 916, the surface area of an electricity generation component thermally coupled to the first heat exchanger 920 can be increased. For some electricity generation components (e.g., thermionic converters and/or the like), the larger surface area can increase the electrical output, thereby increasing the output power of the CHP system 110 (FIG. 1).

Examples of Suitable Thermal Arrangements of Combined Heat and Power Systems with a Residential Appliance

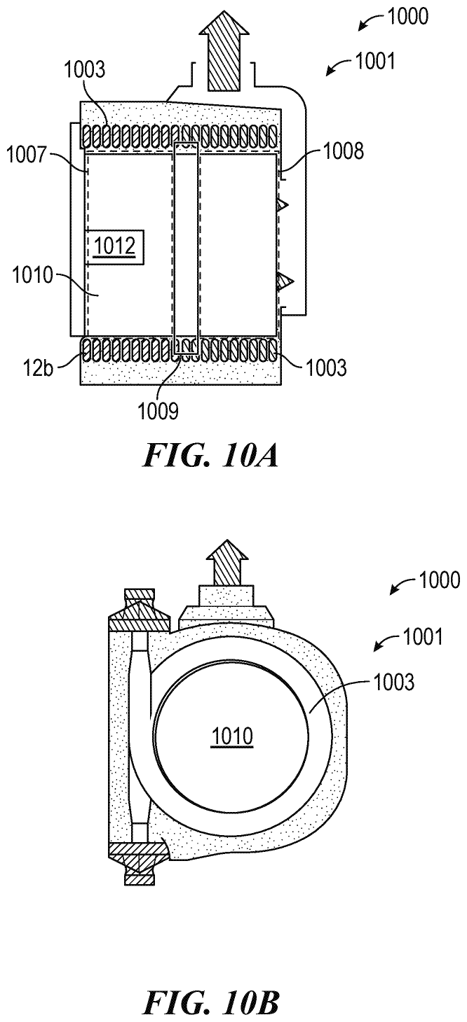

FIGS. 10A-22 illustrate various examples of CHP systems coupled to a typical residential boiler in accordance with some embodiments of the present technology. The illustrated embodiments provide various specific examples of suitable arrangements of the components of the CHP system and the thermal coupling between the CHP system and the residential appliances, which are not meant to be limited to the specific residential boiler application that is illustrated. On the contrary, one of skill in the art will understand that various features of the illustrated embodiments can be applied within various other heating appliances. Purely by way of example, features of the illustrated embodiments can be included in various gas furnaces, other water boilers, steam boilers, water heaters, absorption chillers, heat pumps, and/or the like.

FIGS. 10A and 10B are schematic diagrams of a CHP system 1010 positioned at least partially within a housing 1001 for a heat exchanger within a residential heating appliance 1000 in accordance with some embodiments of the present technology. In the illustrated embodiment, the residential heating appliance 1000 is a typical residential boiler with the housing 1001 containing spiral heat exchangers. As illustrated, the housing 1001 includes a primary space 1007, a secondary space 1008, and an insulation component 1009 thermally isolating the primary space 1007 from the secondary space 1008. The primary and secondary spaces 1007 are surrounded by spiral heat exchangers 1003 that allow fluid to flow therein. In a typical boiler, relatively cold fluids (e.g., water) flow through spiral heat exchangers 1003 in the secondary space 1008, then through the spiral heat exchangers 1003 toward the primary space 1007. A burner positioned in the primary space 1007 heats (and optionally boils) the fluids before they exit the residential heating appliance 1000. Additional details on the operation of a typical boiler will be understood by a person having skill in the art, and are therefore omitted to avoid obscuring the disclosure herein.

As illustrated in FIGS. 10A and 10B, the CHP system 1010 can be sized to be fully positioned within the primary space 1007 and/or the secondary space 1008 of the housing 1001 with few (e.g., minimal) modifications to the existing system. For example, the only modification to the representative residential heating appliance 1000 in the illustrated embodiment is the replacement of the previous burner with the combustion component 1012 of the CHP system 1010.

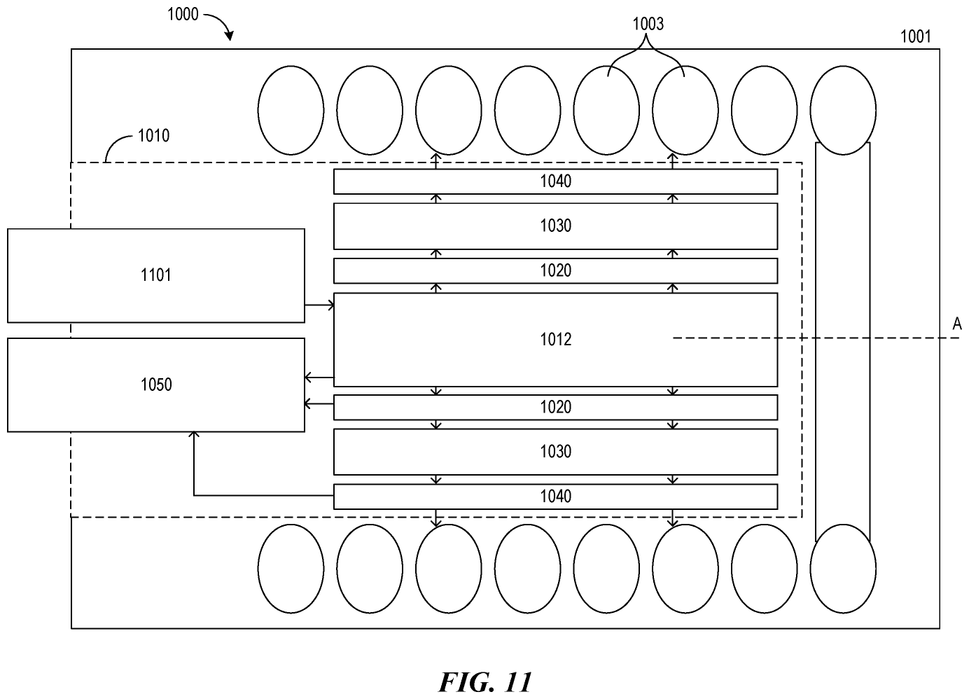

Additional details on the arrangement of the components of the CHP system 1010 and the thermal coupling between the CHP system 1010, the residential heating appliance 1000, and the housing 1001 are described below with respect to FIGS. 11-21. As discussed above, one of skill in the art will understand that these are examples of the application within the residential boiler illustrated. However, the CHP system 1010 can be sized to at least partially within various other heating appliances and/or can make use of any of the arrangements of components discussed below.

FIG. 11 is a schematic diagram of the CHP system 1010 positioned at least partially within a housing 1001 of a residential heating appliance 1000 of the type shown FIGS. 10A and 10B in accordance with some embodiments of the present technology. In the illustrated embodiment, the CHP system 1010 is generally similar to the CHP system 110 discussed above with respect to FIG. 1. For example, the CHP system 1010 includes a combustion component 1012, a first heat exchanger 1020, an electricity generation component 1030, a second heat exchanger 1040, and a recuperator 1050. In the illustrated embodiment, the combustion component 112 is operably coupled to an input supply 1101 to receive a mixture of the fuel and the oxidant. In some embodiments, the input supply 1101 can include a first flow channel for the fuel and a second flow channel for the oxidant, allowing the combustion component 1012 to mix the fuel and oxygen before combustion.

In the illustrated embodiment, several of the components can be positioned annularly about a central axis A, such that first heat exchanger 1020 circumferentially surrounds the combustion component 1012, the electricity generation component 1030 circumferentially surrounds the first heat exchanger 1020, and the second heat exchanger 1040 circumferentially surrounds the electricity generation component 1030. Accordingly, for example, the CHP system 1010 can include any of the thermal coupling features discussed above with respect to FIGS. 3-8. During operation, the mixture is combusted in the combustion component 1012 and hot flue gas is directed into contact with the first heat exchanger 1020. The heat exchanger then conducts heat into the electricity generation component 1030, which uses the received heat to generate an electrical output. Heat that is unused by the electricity generation component 1030 can then flow into the second heat exchanger 1040, which directs the unused heat into the spiral heat exchangers 1003 of the residential heating appliance 1000.

Meanwhile, after the flue gas transfers heat into the first heat exchanger 1020, the flue gas flows into the recuperator 1050. The recuperator 1050 receives at least a portion of the heat that is unused and/or not absorbed by the first heat exchanger 1020. The recuperator 1050 then transfers a portion of the heat absorbed into the recuperator into the mixture flowing to the combustion component 1012 to preheat the mixture.

In the illustrated embodiment, each of the components of the CHP system 1010 is sized to fit at least partially within the primary space 1007 (FIG. 10A) of the housing 1001. Accordingly, the only modification to the residential heating appliance 1000 and the housing 1001 required to incorporate the CHP system 1010 is to replace the preexisting burner with the combustion component 1012 to combust the mixture at a higher temperature. In some embodiments, the residential heating appliance 1000 is also modified to receive at least a portion of the electrical output from the electricity generation component 1030. In such embodiments, the additional modification allows the CHP system 1010 to at least partially power the residential heating appliance 1000, thereby reducing energy demands and/or providing protection against any loss of power (e.g., due to a blackout).

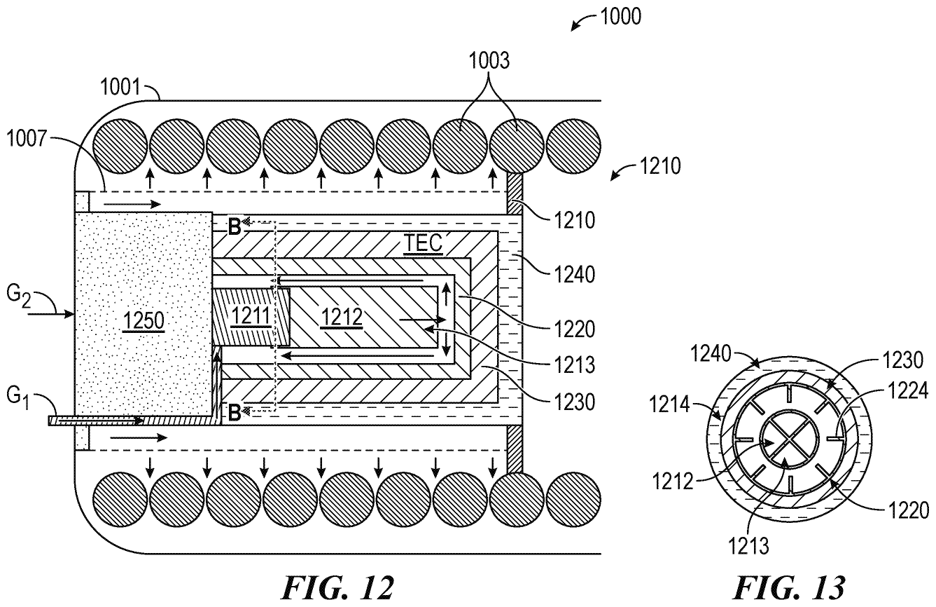

FIG. 12 is a schematic diagram of a CHP system 1210 positioned within a housing 1001 of a residential heating appliance 1000, schematically illustrating the flow of gasses in accordance with some embodiments of the present technology. As illustrated, the CHP system 1210 is generally similar to the CHP system 1010 discussed above with respect to FIG. 11. However, in the illustrated embodiment, the CHP system 1210 is coupled to an input supply that includes a first line G₁ (e.g., natural gas) to direct the fuel and a second input line G₂ to direct the oxidant (e.g., air). Further, in the illustrated embodiment, the combustion component 1212 includes a mixer 1211 and a combustion region 1213. The mixer 1211 receives the fuel and the oxidant and creates the mixture that is combusted in the combustion region 1213. In some embodiments, the mixer 1211 is configured to create a stoichiometric ratio of the fuel and the oxygen in the mixture (e.g., by modulating one or more controllable valves, meters, sensors, and/or the like). After the combustion component 1212 combusts the mixture in the combustion region 1213, flue gas travels out of the combustion component 1212 and into contact with the first heat exchanger 1220 along a longitudinal axis of the combustion component 1212 to transfer heat to the first heat exchanger 1220. The flue gas then passes to the recuperator 1250 to preheat the incoming oxidant.

In the illustrated embodiment, after flowing through the recuperator 1250, the flue gas can flow out of the housing 1001 through the primary space 1007. As the flue gas exits the primary space 1007, the flue gas transfers at least a portion of any unused heat into the spiral heat exchangers 1003. That is, in the illustrated embodiment, the spiral heat exchangers 1003 can receive unused heat from both the exiting flue gas and from the second heat exchanger 1240 in the power cell 114.

FIG. 13 is a partially schematic cross-sectional view of the CHP system 1210 of FIG. 12 in accordance with some embodiments of the present technology. The cross-sectional view is taken along line B-B in FIG. 12 and illustrates additional features of the thermal coupling between the combustion component 1212 and power cell 1214. In particular, in the illustrated embodiment, the first heat exchanger 1220 of the power cell 1214 includes protrusions 1224 that extend into and/or disrupt the flow path of the flue gas exiting the combustion component 1212. As discussed in more detail above, the protrusions 1224 thereby increase the heat flux between the flue gas and the first heat exchanger 1220, thereby increasing the amount of heat transferred into the power cell 1214 overall.

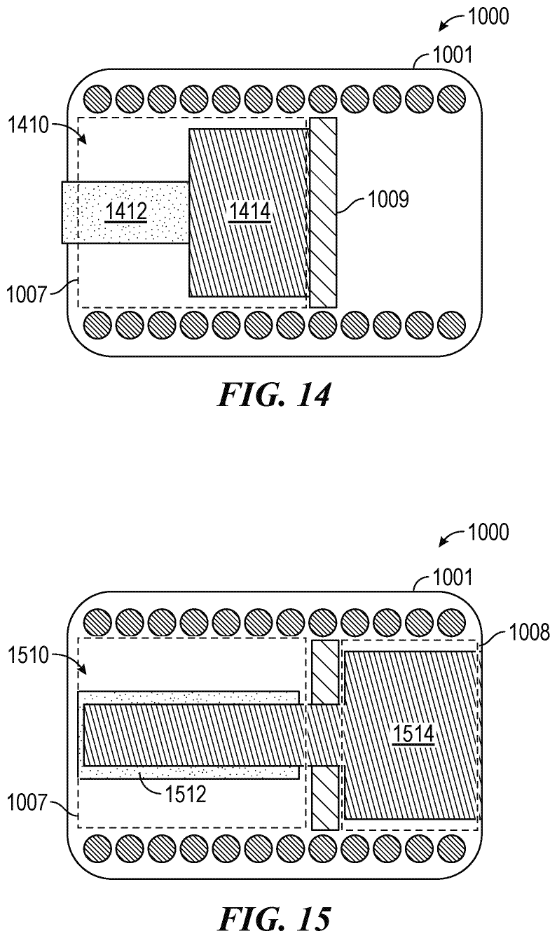

FIGS. 14-19 are schematic diagrams of various CHP systems positioned at least partially within a housing 1001 of a residential heating appliance 1000 in accordance with various embodiments of the present technology. For example, FIG. 14 is a schematic diagram of a CHP system 1410 positioned entirely within the primary space 1007 of the housing 1001. In the illustrated embodiment, the combustion component 1412 and the power cell 1414 are arranged in parallel along a longitudinal axis of the housing 1001, with the insulation component 1009 acting as a backstop for heat flowing through the power cell 1414. The illustrated embodiment can be useful, for example, when the primary thermal connection between the CHP system 1410 and the residential heating appliance 1000 is through the second heat exchanger 140 (e.g., FIG. 1).

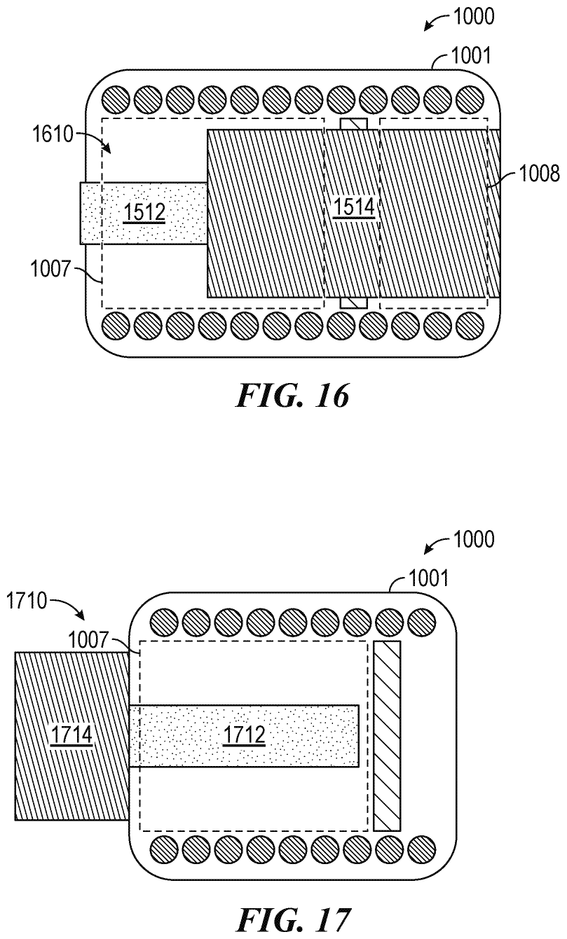

FIGS. 15 and 16 are a schematic diagrams of CHP systems 1510, 1610 positioned entirely within the housing 1001 but split between the primary and secondary spaces 1007, 1008. In the illustrated embodiments, the combustion component 1512 is positioned fully within the primary space 1007 while the power cell 1514 extends from the combustion component 1512 into the secondary space 1008. The illustrated embodiment can be useful, for example, when the combustion component 1512 is also thermally coupled to the residential heating appliance 1000 (e.g., along the sixth gas flow path G₆ discussed above with respect to FIG. 2). That is, the illustrated arrangement provides space for both the combustion component 1512 and the power cell 1514 to be thermally coupled to the residential heating appliance 1000.

FIG. 17 is a schematic diagram of a CHP system 1710 positioned only partially within the primary space 1007 of the housing 1001. In the illustrated embodiment, the combustion component 1712 is positioned fully within the primary space 1007 while the power cell 1714 is positioned external to the housing 1001. The illustrated embodiment can be useful, for example, to minimize modifications to the residential heating appliance 1000 and/or the housing 1001. For example, the only modification required is replacing a conventional burner with the combustion component 1712 to obtain higher combustion temperatures. Additionally, or alternatively, the illustrated embodiment can be useful when the power cell 1714 does not fit within the housing 1001. As a result, the illustrated embodiment of the CHP system 1710 can be compatible with a wider range of heating appliances.

FIG. 18 is a schematic diagram of a CHP system 1810 positioned only partially within the primary space 1007 of the housing 1001. In the illustrated embodiment, the combustion component 1812 and the power cell 1814 are positioned fully within the primary space 1007 while the recuperator 1850 is positioned external to the housing 1001. The illustrated embodiment can be useful, for example, to increase the space available for the recuperator 1850 and therefore the time the recuperator 1850 has to preheat an incoming oxidant. The increased time can allow the recuperator 1850 to direct an increased amount of heat into the incoming oxidant. Additionally, or alternatively, the illustrated embodiment can be useful to allow heat to flow from the power cell 1814 to the recuperator 1850 through conduction. Purely by way of example, a surface of the second heat exchanger 140 (FIG. 1) can be in thermal contact with the recuperator 1850, allowing unused heat to flow from the second heat exchanger 140 to the recuperator 1850 via conduction (e.g., along the fifth heat path H₅, as discussed above with respect to FIG. 2). Additionally, or alternatively, the illustrated embodiment can be useful to reduce the modifications necessary to incorporate the CHP system 1810 with the residential heating appliance 1000 (e.g., by not requiring that the housing 1001 (or any other component of the residential heating appliance 1000) fit the recuperator 1850).

FIG. 19 is a schematic diagram of a CHP system 1910 positioned only partially within the housing 1001. In the illustrated embodiment, the combustion component 112 is positioned fully within the primary space 1007, the power cell 114 is positioned fully within the secondary space 1008, and the recuperator 150 is positioned external to the housing 1001. The illustrated embodiment can be useful, for example, to more fully take advantage of more of the space available within the housing 1001, thereby reducing the overall footprint of the combination of the CHP system 1910 and the residential heating appliance 1000.

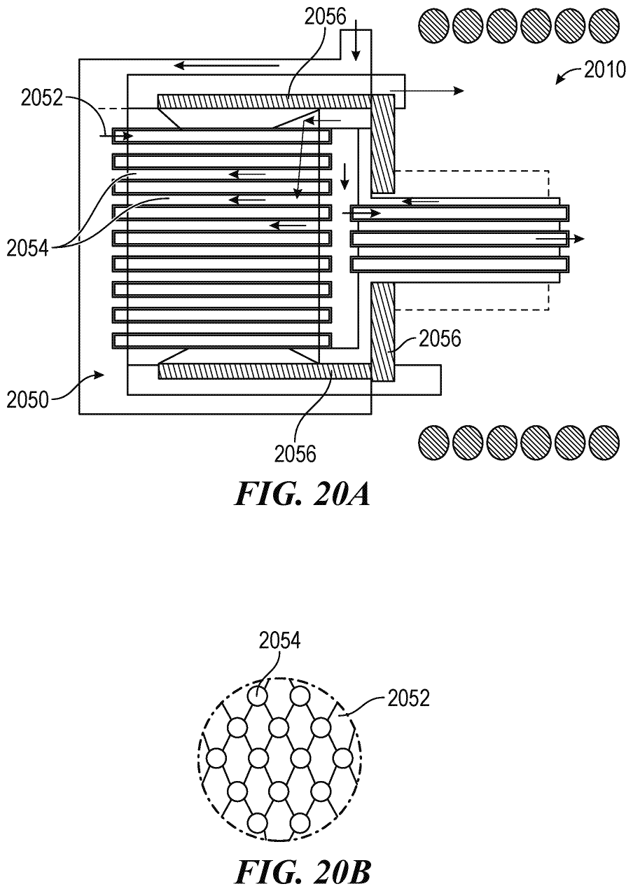

FIGS. 20A and 20B are a schematic diagram and a partially schematic cross-sectional view, respectively, of a recuperator 2050 for a CHP system 2010 configured in accordance with some embodiments of the present technology. In the illustrated embodiment, the CHP system 2010 is arranged similarly to the CHP system 1910 discussed above. For example, the combustion component 1912 and the power cell 1914 (FIG. 19) are positioned fully within the residential heating appliance (not shown) while the recuperator 2050 is positioned at least partially external to the housing of the residential heating appliance.

The recuperator 2050 can include one or more input flow channels 2052, one or more output flow channels 2054, and an insulative housing 2056 at least partially surrounding the input and output flow channels 2052, 2054. That is, as best illustrated in FIG. 20B, the input and output flow channels 2052, 2054 are arranged in a cellular structure. The input flow channels 2052 allow an oxidant (e.g., air, compressed air, oxygen, and/or the like) to flow through the recuperator 2050 and toward the combustion component 112 (FIG. 1). Meanwhile, the output flow channels 2054 allow a flue gas to flow out of the power cell 114 (FIG. 1) and/or the combustion component 112 toward a flue gas output 105. The input flow channels 2052 are positioned adjacent to the output flow channels 2054. Further, a conductive material can be positioned between the input and output flow channels 2052, 2054, thereby allowing the recuperator 2050 to recycle at least a portion of the unused heat from the power cell 114 (FIG. 1) and/or the combustion component 112 to preheat the incoming oxidant.

As best illustrated in FIG. 20A, the insulative housing 2056 can reflect at least a portion of any heat traveling outward from the recuperator 2050 back toward the input and output flow channels 2052, 2054. As a result, insulative housing 2056 can increase the amount of heat the recuperator 2050 is able to recycle by preheating the incoming oxidant.

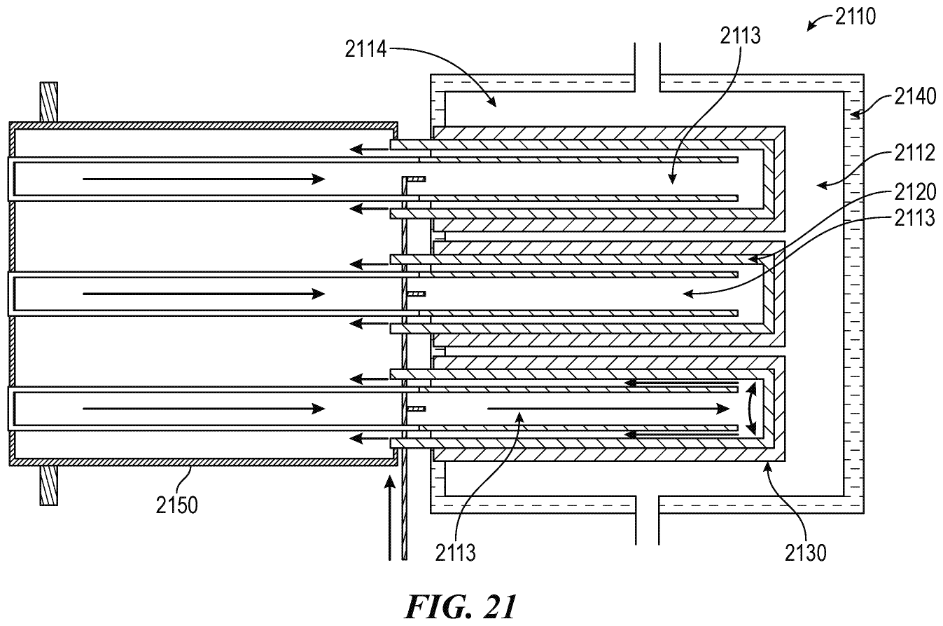

FIG. 21 is a schematic diagram of a CHP system 2110 configured in accordance with some embodiments of the present technology. As illustrated in FIG. 21, the CHP system 2110 is generally similar to the CHP system 1010 discussed above with respect to FIG. 11. For example, the CHP system 2110 includes a combustion component 2112 and power cell 2114 both positioned within a residential heating appliance 2100, with a recuperator 2150 positioned at least partially within the residential heating appliance 2100. However, in the illustrated embodiment, the combustion component 2112 includes a plurality of burners 2113 (three shown) and the power cell 2114 includes features adapted to receive heat from the plurality of burners 2113. For example, the power cell 2114 includes a first heat exchanger 2120 positioned at least partially around each of the plurality of burners 2113 to contact the flue gas flowing out of the burners 2113. Further, the power cell 2114 includes an electricity generation component 2130 in thermal communication with the first heat exchanger 2120 to receive the heat absorbed from the flue gas flowing out of each of the plurality of burners 2113.

As illustrated in FIG. 21, the multi-burner embodiment of the CHP system 2110 can result in a relatively large surface area for the electricity generation component 2130. And, as discussed above, the relatively large surface area of the electricity generation component 2130 can increase the electrical output, thereby increasing the output power of the CHP system 2110 overall. Further, in some embodiments, the plurality of burners 2113 can consume the same amount of input fuel and/or energy while allowing the relatively large surface area of the electricity generation component 2130 to increase the power output of the CHP system 2110. That is, the use of the plurality of burners 2113 can increase the overall efficiency of the CHP system 2110.

In various embodiments, the combustion component 2112 can include any other suitable number of burners. For example, the combustion component 2112 can have one, two, four, five, ten, or any other suitable number of burners. Further, the CHP system 2110 can be scaled based on the number of burners included in the combustion component 2112 in a predictable manner (e.g., the available input heat required and output heat available scales directly with the number of burners). The scalability allows the CHP system 2110 to be customized to a specific residential heating appliance's input heating requirement. Further, the electricity output of the CHP system 2110 can scale with the number of burners included in the combustion component 2112 in a predictable manner. The predictability of the electricity output allows the CHP system 2110 to be scaled to meet the electricity demands of the CHP system 2110 and the residential heating appliance. That is, the CHP system 2110 can be scaled to fully, and confidently, protect the CHP system 2110 and the residential heating appliance against power loss (e.g., from a blackout).

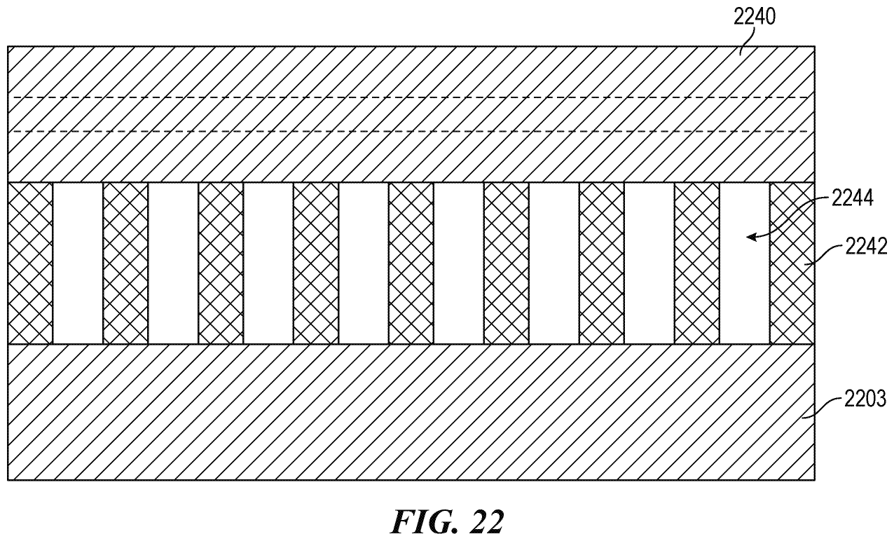

FIG. 22 is a partially schematic cross-sectional view of the thermal coupling between the second heat exchanger 2240 (e.g., the cold side heat exchanger) and a third heat exchanger 2203 of a residential heating appliance in accordance with further embodiments of the present technology. In the illustrated embodiment, the second heat exchanger 2240 is coupled to the third heat exchanger 2203 via conductive fins 2242 that are spaced apart to form air channels 2244. The air channels 2244 can transfer a portion of the heat from the second heat exchanger 2240 away from the third heat exchanger 2203 to avoid supplying too much heat to the third heat exchanger 2203.

For example, as discussed above, the CHP systems disclosed herein can operate a significantly higher temperature than required to operate a residential heating appliance. Purely by way of example, the flue gas exiting the combustion component can be between about 1500° C. and about 2000° C. In such embodiments, the heat flowing out of the second heat exchanger (e.g., the cold side heat exchanger) can still be above 500° C. Meanwhile, residential heating appliances typically operate between about 100° C. to about 400° C. Uncontrolled, the much higher temperatures of the CHP system can produce failures in the residential heating appliance. For example, the high temperatures can result in micro-boiling in a water coil thermally coupled to the second heat exchanger, which undermines the ability of the water coil to effectively absorb heat. Accordingly, by transferring a portion of the heat away from third heat exchanger 2203 through the air channels 2244, the second heat exchanger 2240 can avoid (or reduce) instances of micro-boiling caused by an excessively high temperature.

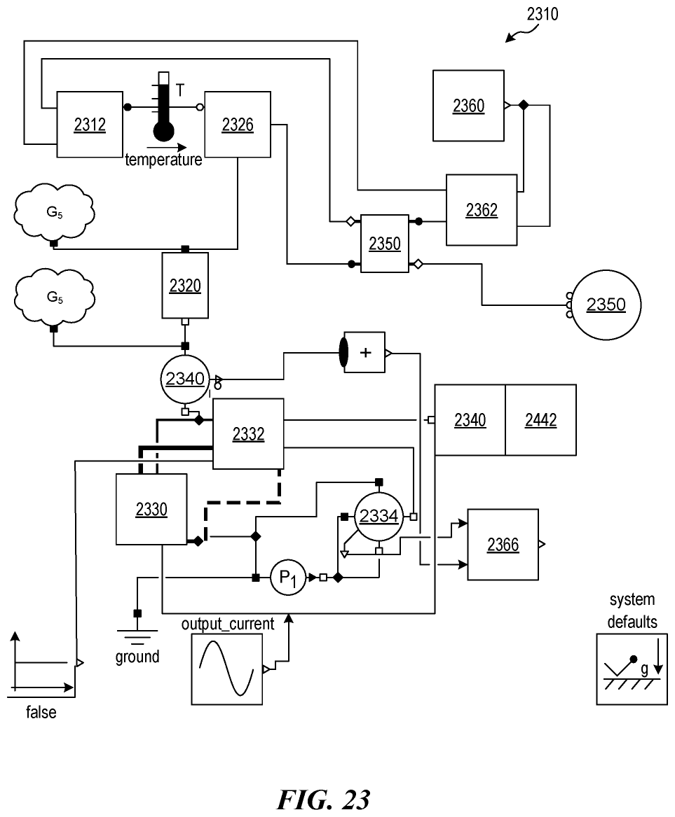

FIG. 23 is a schematic diagram of a CHP system 2310 configured for use with a residential heating appliance in accordance with further embodiments of the present technology. As illustrated in FIG. 23, the CHP system 2310 is generally similar to the CHP system 110 described above with respect to FIG. 1. For example, the CHP system 2310 includes a combustion component 2312, a first heat exchanger 2320, an electricity generation component 2330, a second heat exchanger 2340, and a recuperator 2350. Further, similar to the discussion above, flue gas from the combustion component 2312 can transport heat to the first heat exchanger 2320 and/or the recuperator 2350, then be expelled along the fifth gas flow path G₅; the first heat exchanger 2320 can transfer heat into the electricity generation component 233; the electricity generation component 2330 can transfer heat into the second heat exchanger 2340; and the recuperator 2350 can transfer heat into the incoming oxidant and/or fuel.

As further illustrated in FIG. 23, the CHP system 2310 further includes a controller 2360, a mixer 2362 operably coupled to the controller 2360 and the combustion component 2312, and various sensors and/or meters coupled to various components of the CHP system 2310 and the controller 2360. For example, a flow meter 2326 is positioned between the combustion component 2312 and the first heat exchanger 2320 to measure a volume and/or temperature of flue gas flowing between the two; a current sensor 2332 and an output power sensor 2334 are operably coupled to the electricity generation component 2330 to measure the electrical output from of the electricity generation component 2330; and a hot temperature sensor 2440 and a fixed cold side sensor 2442 are operably coupled to an efficiency calculating circuit 2366 to measure the operating efficiency of the CHP system 2310.

The controller 2360 can be operably coupled to each of the components of the CHP system 2310 to adjust operation of the components. Purely by way of example, the controller 2360 can use temperature measurements from the flow meter 2326 to determine whether the combustion component 2312 is receiving a proper ratio of fuel to oxygen in a fuel mixture. When the temperature drops below a predetermined threshold (e.g., a minimum desired operating temperature for the hot side of the electricity generation component 2330), the controller 2360 can control operation of the mixer 2362 to adjust the ratio of fuel to oxygen in the fuel mixture. In another example, the controller 2360 can use flow measurements from the flow meter 2326 to determine whether the combustion component 2312 is receiving a sufficient volume of the fuel mixture. If the flow drops below a predetermined threshold (e.g., a minimum amount delivering enough output heat to operate the CHP system 2310), the controller 2360 can control operation of the mixer 2362 to increase the volume of the fuel mixture entering the combustion component 2312 and/or check that the combustion component 2312 is properly combusting the fuel mixture.

Additionally, or alternatively, the controller 2360 can be coupled to the components of the CHP system 2310 and/or can be couplable to various external components. Representative components include a battery connected to the electricity generation component 2330 to receive the electrical output; valves connected to the input lines; one or more appliances, such as an associated heating appliance and/or other appliances; one or more meters; and/or the like. In such embodiments, the controller 2360 can determine where to direct the electrical output from the electricity generation component 2330. For example, during periods of low power demand and/or non-blackout periods, the controller 2360 can direct the electrical output to a battery (e.g., in the electric grid 106 of FIG. 1) to store the generated energy. During periods of high demand and/or during a blackout, the controller 2360 can direct the electrical output to specific destinations, such as to valves and/or pumps controlling the fuel and oxidant input, the combustion component, and/or pumps circulating a fluid heated by the unused heat from the CHP system 2310 (e.g., the water in a boiler). That is, the controller 2360 can automatically control the direction of the electrical output to help protect against blackouts or other losses of power and/or to help determine when to supplement energy consumption. Additionally, or alternatively, the controller 2360 can determine when the electrical output is insufficient to meet the demands of the CHP system 2310 and/or related appliances and draw energy from the battery to supplement the electrical output. Purely by way of example, the controller 2360 can draw energy from the battery during a cold start and/or ramp-up phase (e.g., before the CHP system 2310 generates the electrical output and/or before the CHP system 2310 generates the normal amount of the electrical output).

In some embodiments, the illustrated CHP system 2310 can be used as a model to conduct system optimizations before adapting one or more CHP systems to a specific residential appliance. For example, the CHP system 2310 can be used to predict the output power and heat given various loads and/or inputs on the system that are tailored to a target residential appliance. If either of the outputs are unsatisfactory, the actual CHP system implemented with the target residential appliance can be adjusted to account for the predicted outputs.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A combined heat and power system, comprising:
a combustion component operably coupleable to one or more inputs to receive a fuel and oxidant for combustion within the combustion component;
a power cell including:
   a first heat exchanger thermally coupled to the combustion component to receive heat from the combustion in the combustion component;
   a second heat exchanger, wherein the second heat exchanger is thermally coupleable to a heating appliance; and
   an electricity generation component having a first portion thermally coupled to the first heat exchanger and a second portion thermally coupled to the second heat exchanger, wherein the electricity generation component is positioned to generate an electrical output using at least a portion of the heat received at the first heat exchanger.

2. The combined heat and power system of example 1, further comprising a recuperator operably coupled to the power cell to receive unused heat from the power cell, and wherein the recuperator is operably coupleable to the combustion component and at least one of the one or more inputs to transfer at least a portion of the unused heat to the oxidant.

3. The combined heat and power system of example 2, wherein the recuperator is further operably coupleable to a third heat exchanger in the heating appliance to direct at least a portion of the unused heat received from the power cell to the third heat exchanger.

4. The combined heat and power system of any of examples 2 and 3, further comprising a valve operably coupleable between the at least one of the one or more inputs and the recuperator to modulate oxidant flow through the recuperator.

5. The combined heat and power system of any of examples 2-4 wherein the recuperator is fluidly coupled to the power cell, and wherein the unused heat is at least partially transported to the recuperator through flue gas exiting the power cell.

6. The combined heat and power system of any of examples 1-5 wherein the electricity generation component is operably coupleable to an electronics system of the residential appliance to at least partially power the residential appliance.

7. The combined heat and power system of any of examples 1-6 wherein the combustion component is further operably coupleable to a third heat exchanger in the heating appliance to direct at least a portion of the heat from the combustion directly to the third heat exchanger.

8. The combined heat and power system of example 7 wherein the combustion within the combustion component generates a flue gas, and wherein the combined heat and power system the further comprises a valve operably coupleable between the combustion component and the third heat exchanger, wherein:
the valve has a first position to allow at least a portion of the flue gas to bypass the power cell and flow to the third heat exchanger, and a second position to prevent the portion of the flue gas from bypassing the power cell; and
when the valve is in the first position, at least a portion of the heat from the combustion is transported to the third heat exchanger through the at least a portion of the flue gas bypassing the power cell.

9. The combined heat and power system of any of examples 1-8 wherein the first heat exchanger is thermally coupleable to a third heat exchanger in the residential appliance.

10. The combined heat and power system of any of examples 1-9 wherein the residential appliance includes at least one of: a gas furnace, a hot water boiler, a steam boiler, a water heater, an absorption chiller, or a heat pump.

11. The combined heat and power system of any of examples 1-10 wherein the electricity generation component includes one or more of a thermionic energy converter, a thermoelectric energy converter, or an alkali metal thermal-to-electricity converter.

12. The combined heat and power system of any of examples 1-11 wherein the second heat exchanger is thermally coupleable to a third heat exchanger in the heating appliance.

13. The combined heat and power system of examples 12 wherein the third heat exchanger includes a spiral heat exchanger, and wherein the combustion component and the power cell are sized to be positioned at least partially within the spiral heat exchanger.

14. The combined heat and power system of example 12 wherein the third heat exchanger includes a spiral heat exchanger, and wherein the combustion component and the power cell are sized to be positioned fully within the spiral heat exchanger.

15. The combined heat and power system of any of examples 1-11 wherein the second heat exchanger is directly thermally coupleable to a fluid in the heating appliance.

16. The combined heat and power system of any of examples 1-15 wherein the first heat exchanger is in fluid communication with the combustion component to receive the heat from the combustion at least partially through convection of flue gas from the combustion, and wherein the first heat exchanger includes one or more fins in a flow path of the flue gas to cause turbulence in the flow path.

17. The combined heat and power system of any of examples 1-16 wherein the combustion component includes:
a burner positioned to direct flue gas from the combustion along a flow path toward the first heat exchanger; and
an intermediate substrate positioned at least partially within the flow path to absorb at least a portion of the heat from the combustion from the flue gas and radiate the absorbed heat toward the first heat exchanger.

18. The combined heat and power system of any of examples 1-17 wherein the combustion component includes a porous burner positioned adjacent the first heat exchanger, and wherein the first heat exchanger is positioned to be thermally coupled to the porous burner at least partially through heat radiation from the porous burner.

19. The combined heat and power system of any of examples 1-14 wherein the combustion component includes a reverse swiss roll burner having a combustion point adjacent an external surface of the reverse swiss roll burner, and wherein the first heat exchanger is thermally coupled to the external surface of the reverse swiss roll burner.

20. The combined heat and power system of example 19 wherein the reverse swiss roll burner further includes a recuperator flow channel along at least a portion of the external surface and an input flow channel to direct at least a first portion of the heat from the combustion through the external surface and at least a second portion of the heat from the combustion into the input flow channel to preheat the oxidant in the input flow channel.

21. The combined heat and power system of any of examples 1-20, further comprising a mixer operably coupleable between the combustion component and the one or more inputs to receive the combustive fuel and the oxygen and deliver a combustion ratio of the combustive fuel and the oxygen to the combustion component that is within 10 percent of a stoichiometric ratio of the combustive fuel and the oxygen.

23. The combined heat and power system of any of examples 1-20, further comprising:
a battery operably coupled to the electricity generation component to receive the electrical output; and
a controller operably coupled to the combustion component, the power cell, and the battery, wherein the controller includes instructions that when executed cause the controller to control the battery to supply power to the combustion component and the power cell to maintain operation of the combustion component and the power cell during a blackout.

23. A combined heat and power system for use with a heating appliance, the system comprising:
a combustion component having a plurality of burners, wherein an individual burner is operably coupleable to a fuel supply and an air supply to receive fuel and air, respectively, for combustion resulting in a flue gas;
a power generation module including:
   a first heat exchanger thermally coupled to the combustion component to receive heat from the flue gas;
   a power generation component thermally coupled to the first heat exchanger to generate an electrical output from at least a portion of the heat received at the first heat exchanger; and
   a second heat exchanger thermally coupled to the power generation component, the second heat exchanger operably coupleable to an external heat exchanger to transfer a first portion of unused heat from the power generation module; and
a recuperator operably coupleable between the plurality of burners and the air supply, wherein the recuperator is thermally coupled to the power generation module to direct a second portion of the unused heat into thermal communication with the air.

24. The combined heat and power system of example 23 wherein the power generation component includes one or more of a thermionic energy converter, a thermoelectric energy converter, or an alkali metal thermal-to-electricity converter.

25. The combined heat and power system of any of examples 23 and 24 wherein the heating appliance includes one of: a gas furnace, a hot water boiler, a steam boiler, a water heater, an absorption chiller, or a heat pump.

26. The combined heat and power system of any of examples 23-25 wherein the electrical output is less than 5 kilowatts.

27. The combined heat and power system of any of examples 23-26 wherein the electrical output is less than 1 kilowatt.

28. The combined heat and power system of any of examples 23-27 wherein at least one of the plurality of burners is thermally coupleable to the external heat exchanger to bypass the power cell and transport the heat from the at least one of the plurality of burners to the external heat exchanger.

29. The combined heat and power system of any of examples 23-28 wherein the combustion component further includes a mixer operably coupleable among the plurality of burners, the fuel supply, and the air supply to receive the fuel and the air and deliver a combustion ratio of the combustive fuel and the oxygen to the plurality of burners that is within 10 percent of a stoichiometric ratio of the combustive fuel and oxygen in the air.

30. The combined heat and power system of any of examples 23-29 wherein the combustion component, the power generation module, and the recuperator are sized to fit within a primary space of the heating appliance.

31. The combined heat and power system of any of examples 23-29 wherein the combustion component and the power generation module are sized to fit within a primary space of the heating appliance, and wherein the recuperator is operably coupleable to an exterior of the heating appliance.

32. The combined heat and power system of any of examples 23-29 wherein the combustion component is positionable within a primary space of the heating appliance, and wherein the power generation module is positionable at least partially within a secondary space of the heating appliance.

33. The combined heat and power system of any of examples 23-29 wherein the combustion component is positionable within a primary space of the heating appliance, and wherein the power generation module is positionable fully within a secondary space of the heating appliance.

34. The combined heat and power system of any of examples 23-33 wherein the second heat exchanger is thermally coupled to the external heat exchanger via a plurality of conductive fins spaced apart to form air channels positioned to transfer a third portion of the unused heat away from the external heat exchanger.

35. A method for operating a combined heat and power system, the method comprising:
combusting, within a combustion component, a mixture to produce combustion heat carried by a flue gas, the mixture including a fuel and air;
directing at least a portion of the combustion heat into a first heat exchanger of a power cell component;
generating, from at least some of the portion of the combustion heat, an electrical output at the power cell component;
directing unused heat not converted into the electrical output to a second heat exchanger; and
transferring at least a portion of the unused heat from the second heat exchanger to a heating appliance.

36. The method of example 35 wherein the portion of the combustion heat directed into the first heat exchanger is a first portion of the combustion heat, and wherein the method further comprises directing a second portion of the combustion heat into a recuperator to preheat the air used in the combustion.

37. The method of any of examples 35 and 36 wherein the unused heat transferred to the heating appliance is a first portion of the unused heat, and wherein the method further comprises directing a second portion of the unused heat into a recuperator to preheat the air used in the combustion.

38. The method of any of examples 35-37, further comprising at least partially powering the heating appliance using the electrical output.

39. The method of any of examples 35-38 wherein generating the electrical output includes using one or more of a thermionic energy converter, a thermoelectric energy converter, or an alkali metal thermal-to-electricity converter to convert the portion of the combustion heat transferred into the first heat exchanger into electricity.

40. The method of any of examples 35-39, further comprising, before combusting the mixture, mixing the fuel and air and delivering a combustion ratio of the combustive fuel and the oxygen to the combustion component that is within 10 percent of a stoichiometric ratio of the fuel and oxygen in the air to the combustion component.

41. The method of any of examples 35-40 wherein the portion of the combustion heat transferred into the first heat exchanger is a first portion of the combustion heat, and wherein the method further comprises transferring a second portion of the combustion heat to the heating appliance bypassing the first heat exchanger.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10 percent of a given value or limit. Purely by way of example, an approximate ratio means within a ten percent of the given ratio.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Further, although primarily discussed herein as CHP systems for use within a residential heating appliance, one of skill in the art will understand that the scope of the present technology is not so limited. For example, the CHP systems disclosed herein can be used in various other settings, such as in conjunction residential appliances but not within them; in conjunction with shared electric generators and heating systems (e.g., an electric generator serving more than one residential unit that is thermally coupled to one or more heating systems); in conjunction with commercial building heating and thermally-driven cooling appliances. Accordingly, the scope of the present technology is not confined to any subset of embodiments.

Although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A combined heat and power system, comprising:
a combustion component operably coupleable to one or more inputs to receive a fuel and oxidant for combustion within the combustion component;
a power cell including:
a first heat exchanger thermally coupled to the combustion component to receive heat from the combustion in the combustion component;
a second heat exchanger, wherein the second heat exchanger is thermally coupleable to a heating appliance; and
an electricity generation component having a first portion thermally coupled to the first heat exchanger and a second portion thermally coupled to the second heat exchanger, wherein the electricity generation component is positioned to generate an electrical output using at least a portion of the heat received at the first heat exchanger.

2. The combined heat and power system of claim 1, further comprising a recuperator operably coupled to the power cell to receive unused heat from the power cell, and wherein the recuperator is operably coupleable to the combustion component and at least one of the one or more inputs to transfer at least a portion of the unused heat to the oxidant.

3. The combined heat and power system of claim 2 wherein the recuperator is further operably coupleable to a third heat exchanger in the heating appliance to direct at least a portion of the unused heat received from the power cell to the third heat exchanger.

4. The combined heat and power system of claim 2, further comprising a valve operably coupleable between the at least one of the one or more inputs and the recuperator to modulate oxidant flow through the recuperator.

5. The combined heat and power system of claim 2 wherein the recuperator is fluidly coupled to the power cell, and wherein the unused heat is at least partially transported to the recuperator through flue gas exiting the power cell.

6. The combined heat and power system of claim 1 wherein the electricity generation component is operably coupleable to an electronics system of the residential appliance to at least partially power the residential appliance.

7. The combined heat and power system of claim 1 wherein the combustion component is further operably coupleable to a third heat exchanger in the heating appliance to direct at least a portion of the heat from the combustion directly to the third heat exchanger.

8. The combined heat and power system of claim 7 wherein the combustion within the combustion component generates a flue gas, and wherein the combined heat and power system the further comprises a valve operably coupleable between the combustion component and the third heat exchanger, wherein:
the valve has a first position to allow at least a portion of the flue gas to bypass the power cell and flow to the third heat exchanger, and a second position to prevent the portion of the flue gas from bypassing the power cell; and
when the valve is in the first position, at least a portion of the heat from the combustion is transported to the third heat exchanger through at least a portion of the flue gas bypassing the power cell.

9. The combined heat and power system of claim 1 wherein the first heat exchanger is thermally coupleable to a third heat exchanger in the heating appliance.

10. The combined heat and power system of claim 1 wherein the heating appliance includes at least one of: a gas furnace, a hot water boiler, a steam boiler, a water heater, an absorption chiller, or a heat pump.

11. The combined heat and power system of claim 1 wherein the electricity generation component includes one or more of a thermionic energy converter, a thermoelectric energy converter, or an alkali metal thermal-to-electricity converter.

12. The combined heat and power system of claim 1 wherein the second heat exchanger is thermally coupleable to a third heat exchanger in the heating appliance.

13. The combined heat and power system of claim 12 wherein the third heat exchanger includes a spiral heat exchanger, and wherein the combustion component and the power cell are sized to be positioned at least partially within the spiral heat exchanger.

14. The combined heat and power system of claim 12 wherein the third heat exchanger includes a spiral heat exchanger, and wherein the combustion component and the power cell are sized to be positioned fully within the spiral heat exchanger.

15. The combined heat and power system of claim 1 wherein the second heat exchanger is directly thermally coupleable to a fluid in the heating appliance.

16. The combined heat and power system of claim 1 wherein the first heat exchanger is in fluid communication with the combustion component to receive the heat from the combustion at least partially through convection of flue gas from the combustion, and wherein the first heat exchanger includes one or more fins in a flow path of the flue gas to cause turbulence in the flow path.

17. The combined heat and power system of claim 1 wherein the combustion component includes:
a burner positioned to direct flue gas from the combustion along a flow path toward the first heat exchanger; and
an intermediate substrate positioned at least partially within the flow path to absorb at least a portion of the heat from the combustion from the flue gas and radiate the absorbed heat toward the first heat exchanger.

18. The combined heat and power system of claim 1 wherein the combustion component includes a porous burner positioned adjacent to the first heat exchanger, and wherein the first heat exchanger is positioned to be thermally coupled to the porous burner at least partially through heat radiation from the porous burner.

19. The combined heat and power system of claim 1 wherein the combustion component includes a reverse swiss roll burner having a combustion point adjacent an external surface of the reverse swiss roll burner, and wherein the first heat exchanger is thermally coupled to the external surface of the reverse swiss roll burner.

20. The combined heat and power system of claim 19 wherein the reverse swiss roll burner further includes a recuperator flow channel along at least a portion of the external surface and an input flow channel to direct at least a first portion of the heat from the combustion through the external surface and at least a second portion of the heat from the combustion into the input flow channel to preheat the oxidant in the input flow channel.

21. The combined heat and power system of claim 1, further comprising a mixer operably coupleable between the combustion component and the one or more inputs to receive the combustive fuel and the oxygen and deliver a combustion ratio of the combustive fuel and the oxygen to the combustion component that is at least approximately a stoichiometric ratio of the combustive fuel and the oxygen .

22. The combined heat and power system of any of claim 1, further comprising:
a battery operably coupled to the electricity generation component to receive the electrical output; and
a controller operably coupled to the combustion component, the power cell, and the battery, wherein the controller includes instructions that when executed cause the controller to control the battery to supply power to the combustion component and the power cell to maintain operation of the combustion component and the power cell during a blackout.

23. A combined heat and power system for use with a heating appliance, the system comprising:
a combustion component having a plurality of burners, wherein an individual burner is operably coupleable to a fuel supply and an air supply to receive fuel and air, respectively, for combustion resulting in a flue gas;
a power generation module including:
a first heat exchanger thermally coupled to the combustion component to receive heat from the flue gas;
a power generation component thermally coupled to the first heat exchanger to generate an electrical output from at least a portion of the heat received at the first heat exchanger; and
a second heat exchanger thermally coupled to the power generation component, the second heat exchanger operably coupleable to an external heat exchanger to transfer a first portion of unused heat from the power generation module; and
a recuperator operably coupleable between the plurality of burners and the air supply, wherein the recuperator is thermally coupled to the power generation module to direct a second portion of the unused heat into thermal communication with the air.

24. The combined heat and power system of claim 23 wherein the power generation component includes one or more of a thermionic energy converter, a thermoelectric energy converter, or an alkali metal thermal-to-electricity converter.

25. The combined heat and power system of claim 23 wherein the heating appliance includes one of: a gas furnace, a hot water boiler, a steam boiler, a water heater, an absorption chiller, or a heat pump.

26. The combined heat and power system of claim 23 wherein the electrical output is less than 5 kilowatts.

27. The combined heat and power system of claim 23 wherein the electrical output is less than 1 kilowatt.

28. The combined heat and power system of claim 23 wherein at least one of the plurality of burners is thermally coupleable to the external heat exchanger to bypass the power cell and transport the heat from the at least one of the plurality of burners to the external heat exchanger.

29. The combined heat and power system of claim 23 wherein the combustion component further includes a mixer operably coupleable among the plurality of burners, the fuel supply, and the air supply to receive the fuel and the air and deliver a combustion ratio of the combustive fuel and the oxygen to the plurality of burners that is at least approximately a stoichiometric ratio of the combustive fuel and oxygen in the air to the plurality of burners for stoichiometric combustion.

30. The combined heat and power system of claim 23 wherein the combustion component, the power generation module, and the recuperator are sized to fit within a primary space of the heating appliance.

31. The combined heat and power system of claim 23 wherein the combustion component and the power generation module are sized to fit within a primary space of the heating appliance, and wherein the recuperator is operably coupleable to an exterior of the heating appliance.

32. The combined heat and power system of claim 23 wherein the combustion component is positionable within a primary space of the heating appliance, and wherein the power generation module is positionable at least partially within a secondary space of the heating appliance.

33. The combined heat and power system of claim 23 wherein the combustion component is positionable within a primary space of the heating appliance, and wherein the power generation module is positionable fully within a secondary space of the heating appliance.

34. The combined heat and power system of claim 23 wherein the second heat exchanger is thermally coupled to the external heat exchanger via a plurality of conductive fins spaced apart to form air channels positioned to transfer a third portion of the unused heat away from the external heat exchanger.

35. A method for operating a combined heat and power system, the method comprising:
combusting, within a combustion component, a mixture to produce combustion heat carried by a flue gas, the mixture including a fuel and air;
directing at least a portion of the combustion heat into a first heat exchanger of a power cell component;
generating, from at least some of the portion of the combustion heat, an electrical output at the power cell component;
directing unused heat not converted into the electrical output to a second heat exchanger; and
transferring at least a portion of the unused heat from the second heat exchanger to a fluid in a heating appliance.

36. The method of claim 35 wherein the portion of the combustion heat directed into the first heat exchanger is a first portion of the combustion heat, and wherein the method further comprises directing a second portion of the combustion heat into a recuperator to preheat the air used in the combustion.

37. The method of claim 35 wherein the unused heat transferred to the fluid is a first portion of the unused heat, and wherein the method further comprises directing a second portion of the unused heat into a recuperator to preheat the air used in the combustion.

38. The method of claim 35, further comprising at least partially powering the heating appliance using the electrical output.

39. The method of claim 35 wherein generating the electrical output includes using one or more of a thermionic energy converter, a thermoelectric energy converter, or an alkali metal thermal-to-electricity converter to convert the portion of the combustion heat transferred into the first heat exchanger into electricity.

40. The method of claim 35, further comprising, before combusting the mixture, mixing the fuel and the air and delivering a combustion ratio of the combustive fuel and the oxygen to the combustion component that is at least approximately a stoichiometric ratio of the fuel and oxygen in the air to the combustion component.

41. The method of claim 35 wherein the portion of the combustion heat transferred into the first heat exchanger is a first portion of the combustion heat, and wherein the method further comprises transferring a second portion of the combustion heat to the heating appliance bypassing the first heat exchanger.
